(19) United States
(12) Patent Application Publication
(10) Pub. No.: US 2026/0225491 A1
(43) Pub. Date: Aug. 6, 2026

(54) CONTROL METHOD AND CONTROL APPARATUS

(71) Applicant: Panasonic Intellectual Property Management Co., Ltd., Osaka (JP)

(72) Inventor: BILGUUN SAINBAYAR, Kanagawa (JP)

(21) Appl. No.: 19/635,881

(22) Filed: Apr. 1, 2026

Related U.S. Application Data
(63) Continuation of application No. PCT/JP2024/033057, filed on Sep. 17, 2024.

(30) Foreign Application Priority Data
Oct. 13, 2023 (JP) 2023-177886

(51) Int. Cl. B60L 55/00; B60L 53/30; B60L 53/62; B60L 53/66

(52) U.S. Cl. CPC B60L 55/00; B60L 53/305; B60L 53/62; B60L 53/66

(57) ABSTRACT

A control method of the present disclosure includes, in supplying electric power of at least one electric vehicle parked in a facility to an electric power system or at least one power receiving apparatus in the facility, receiving information that a user of the electric vehicle inputted via a terminal and that indicates an SOC (state of charge) at which the user of the electric vehicle wishes for supply of the electric power of the electric vehicle to be stopped and stopping the supply of the electric power of the electric vehicle when the SOC at which the user of the electric vehicle wishes for the supply of the electric power of the electric vehicle to be stopped is reached.

### BACKGROUND

### 1. TECHNICAL FIELD

The present disclosure relates to a technology with which to supply electric power of an electric vehicle to an electric power system or a power receiving apparatus.

### 2. Description of the Related Art

Conventionally, there has been known a technology with which to supply electric power of an electric vehicle to an electric power system or a power receiving apparatus (see, for example, Japanese Unexamined Patent Application Publication No. 2007-282383).

### SUMMARY

In supplying electric power of an electric vehicle to an electric power system or a power receiving apparatus, no consideration is given to a wish of a user of the electric vehicle for the SOC (state of charge) of a battery of the electric vehicle.

One non-limiting and exemplary embodiment provides a control method and a control apparatus that, in supplying electric power of an electric vehicle to an electric power system or a power receiving apparatus, give consideration to a wish of a user of the electric vehicle for the SOC of a battery of the electric vehicle.

In one general aspect, the techniques disclosed here feature a control method according to an aspect of the present disclosure includes, in supplying electric power of at least one electric vehicle parked in a facility to an electric power system or at least one power receiving apparatus in the facility, receiving information that a user of the electric vehicle inputted via a terminal and that indicates an SOC (state of charge) at which the user of the electric vehicle wishes for supply of the electric power of the electric vehicle to be stopped and stopping the supply of the electric power of the electric vehicle when the SOC at which the user of the electric vehicle wishes for the supply of the electric power of the electric vehicle to be stopped is reached.

According to the control method and the control apparatus according to the present disclosure, in supplying electric power of an electric vehicle to an electric power system or a power receiving apparatus, a wish of a user of the electric vehicle for the SOC of a battery of the electric vehicle is better satisfied than has conventionally been the case.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram showing an example of a hardware configuration of an electric power charge and discharge system according to Embodiment 1;

FIG. 2 is a block diagram showing an example of a functional configuration of a control apparatus and charge and discharge devices according to Embodiment 1;

FIG. 3 is a sequence diagram of a first electric power discharge process that is performed by the electric power charge and discharge system according to Embodiment 1;

FIG. 4 is a sequence diagram of a first message A display process that is performed by the electric power charge and discharge system according to Embodiment 1;

FIG. 5 is a sequence diagram of a first message B display process that is performed by the electric power charge and discharge system according to Embodiment 1;

FIG. 6 is a sequence diagram of a first message C display process that is performed by the electric power charge and discharge system according to Embodiment 1;

FIG. 7 is a sequence diagram of a first message D display process that is performed by the electric power charge and discharge system according to Embodiment 1;

FIG. 8 is a sequence diagram of a first message E display process that is performed by the electric power charge and discharge system according to Embodiment 1;

FIG. 9 is a sequence diagram of a first message FG display process that is performed by the electric power charge and discharge system according to Embodiment 1;

FIG. 10 is a sequence diagram of a first message H display process that is performed by the electric power charge and discharge system according to Embodiment 1;

FIG. 11 is a block diagram showing an example of a hardware configuration of an electric power charge and discharge system according to Embodiment 2;

FIG. 12 is a block diagram showing an example of a functional configuration of a control apparatus and charge and discharge devices according to Embodiment 2;

FIG. 13 is a sequence diagram of a second electric power discharge process that is performed by the electric power charge and discharge system according to Embodiment 2;

FIG. 14 is a sequence diagram of a second message A display process that is performed by the electric power charge and discharge system according to Embodiment 2;

FIG. 15 is a sequence diagram of a second message B display process that is performed by the electric power charge and discharge system according to Embodiment 2;

FIG. 16 is a sequence diagram of a second message C display process that is performed by the electric power charge and discharge system according to Embodiment 2;

FIG. 17 is a sequence diagram of a second message D display process that is performed by the electric power charge and discharge system according to Embodiment 2;

FIG. 18 is a sequence diagram of a second message E display process that is performed by the electric power charge and discharge system according to Embodiment 2;

FIG. 19 is a sequence diagram of a second message FG display process that is performed by the electric power charge and discharge system according to Embodiment 2;

FIG. 20 is a sequence diagram of a second message H display process that is performed by the electric power charge and discharge system according to Embodiment 2;

FIG. 21 is a block diagram showing an example of a hardware configuration of an electric power charge and discharge system according to Embodiment 3;

FIG. 22 is a block diagram showing an example of a functional configuration of a control apparatus according to Embodiment 3;

FIG. 23 is a sequence diagram of a third electric power discharge process that is performed by the electric power charge and discharge system according to Embodiment 3;

FIG. 24 is a sequence diagram of a third message A display process that is performed by the electric power charge and discharge system according to Embodiment 3;

FIG. 25 is a sequence diagram of a third message B display process that is performed by the electric power charge and discharge system according to Embodiment 3;

FIG. 26 is a sequence diagram of a third message C display process that is performed by the electric power charge and discharge system according to Embodiment 3;

FIG. 27 is a sequence diagram of a third message D display process that is performed by the electric power charge and discharge system according to Embodiment 3;

FIG. 28 is a sequence diagram of a third message E display process that is performed by the electric power charge and discharge system according to Embodiment 3;

FIG. 29 is a sequence diagram of a third message FG display process that is performed by the electric power charge and discharge system according to Embodiment 3; and

FIG. 30 is a sequence diagram of a third message H display process that is performed by the electric power charge and discharge system according to Embodiment 3.

### DETAILED DESCRIPTIONS

### Underlying Knowledge Forming Basis of an Aspect of the Present Disclosure

The inventors are advancing the development of a system that makes it possible to, at a facility serving as an electric power demander who is supplied with electric power from an electric power company, be supplied with electric power from an electric vehicle parked at the facility and thereby reducing a demand charge that is levied on the facility by the electric power company.

The inventors found through this development that in supplying electric power of an electric vehicle to an electric power system or a power receiving apparatus, there occurs a phenomenon in which the electric power of the electric vehicle is supplied to the electric power system or the power receiving apparatus until the electric power of the electric vehicle becomes less than an SOC that a user of the electric vehicle wishes.

To address the problem, the inventors diligently conducted experiments and studies to reduce the occurrence of such a phenomenon. As a result of that, the inventors conceived of a control method and a control apparatus according to the present disclosure described below.

A control method according to an aspect of the present disclosure includes, in supplying electric power of at least one electric vehicle parked in a facility to an electric power system or at least one power receiving apparatus in the facility, receiving information that a user of the electric vehicle inputted via a terminal and that indicates an SOC (state of charge) at which the user of the electric vehicle wishes for supply of the electric power of the electric vehicle to be stopped and stopping the supply of the electric power of the electric vehicle when the SOC at which the user of the electric vehicle wishes for the supply of the electric power of the electric vehicle to be stopped is reached.

The control method causes the supply of electric power from the electric vehicle to the electric power system or the power receiving apparatus to be stopped when the SOC at which the user of the electric vehicle wishes for the supply of the electric power of the electric vehicle to be stopped is reached.

Accordingly, the control method makes it possible to, in supplying the electric power of the electric vehicle to the electric power system or the power receiving apparatus, inhibit the electric power of the electric vehicle from being supplied until the electric power of the electric vehicle becomes less than an SOC that the user of the electric vehicle wishes.

Further, when the SOC at which the user of the electric vehicle wishes for the supply of the electric power of the electric vehicle to be stopped is less than an SOC needed for the electric vehicle to arrive at a destination from the facility, an error message or a message that suggests modifying the SOC at which the user of the electric vehicle wishes for the supply of the electric power of the electric vehicle to be stopped may be displayed on a screen of the terminal.

This makes it possible to, when the electric power of the electric vehicle is supplied to the electric power system or the power receiving apparatus, inhibit the SOC of the electric vehicle after the supply of the electric power from becoming less than the SOC needed to arrive at the destination from the facility.

Further, when a capacity of an electric storage device serving as the power receiving apparatus is exceeded when the electric power of the electric vehicle is supplied to the electric storage device until the SOC at which the user of the electric vehicle wishes for the supply of the electric power of the electric vehicle to be stopped is reached, an error message or a message that suggests modifying the SOC at which the user of the electric vehicle wishes for the supply of the electric power of the electric vehicle to be stopped may be displayed on a screen of the terminal.

This makes it possible to, when the electric power of the electric vehicle is supplied to the electric storage device serving as the power receiving apparatus, inhibit electric power supplied from the electric vehicle to the electric storage device from exceeding the capacity of the electric storage device.

Further, when a power purchase demand of the electric power system is exceeded when the electric power of the electric vehicle is supplied to the electric power system until the SOC at which the user of the electric vehicle wishes for the supply of the electric power of the electric vehicle to be stopped is reached, an error message or a message that suggests modifying the SOC at which the user of the electric vehicle wishes for the supply of the electric power of the electric vehicle to be stopped may be displayed on a screen of the terminal.

This makes it possible to, when the electric power of the electric vehicle is supplied to the electric power system, inhibit electric power supplied from the electric vehicle to the electric power system from exceeding the power purchase demand of the electric power system.

Further, the control method may further include calculating, on the basis of received information that indicates the SOC at which the user of the electric vehicle wishes for the supply of the electric power of the electric vehicle to be stopped, a period of time during which the supply of the electric power of the electric vehicle is executed and displaying, on a screen of the terminal, information that indicates the period of time thus calculated.

This allows the user of the electric vehicle to recognize the period of time during which the supply of the electric power of the electric vehicle is executed.

Further, the control method may further include causing the terminal to display information that checks with the user of the electric vehicle whether the user of the electric vehicle allows for a period of time during which the supply of the electric power of the electric vehicle is executed.

This allows the user of the electric vehicle to check whether to allow for a period of time during which the supply of the electric power of the electric vehicle is executed.

Further, the control method may further include receiving information that indicates that the user of the electric vehicle does not allow for a period of time during which the supply of the electric power of the electric vehicle is executed and, upon receiving the information that indicates that the user of the electric vehicle does not allow for a period of time during which the supply of the electric power of the electric vehicle is executed, causing the terminal to display information that prompts inputting of information that indicates a period of time during which the user of the electric vehicle wishes for the supply of the electric power of the electric vehicle to be executed.

This makes it possible to prompt the user of the electric vehicle to input a period of time during which the user of the electric vehicle wishes for the supply of the electric power of the electric vehicle to be executed.

Further, the control method may further include receiving information that the user of the electric vehicle inputted via a screen of the terminal and that indicates a period of time during which the user of the electric vehicle wishes for the supply of the electric power of the electric vehicle to be executed. The supply of the electric power of the electric vehicle may be executed over the period of time thus received during which the user of the electric vehicle wishes for the supply of the electric power of the electric vehicle to be executed.

This makes it possible to supply the electric power of the electric vehicle over the period of time during which the user of the electric vehicle wishes for the supply of the electric power of the electric vehicle to be executed.

Further, supply power from the electric vehicle may be adjusted so as not to exceed an amount of electricity demanded by a different electric vehicle serving as the power receiving apparatus.

This makes it possible to, when the electric power of the electric vehicle is supplied to a different electric vehicle serving as the power receiving apparatus, inhibit electric power supplied from the electric vehicle to the different electric vehicle from exceeding the amount of electricity demanded by the different electric vehicle.

Further, the control method may further include causing the terminal to display a lower-limit value of an SOC that the user of the electric vehicle inputs via the terminal and at which the user of the electric vehicle wishes for the supply of the electric power of the electric vehicle to be stopped. The lower-limit value may be set to such a value as not to exceed a capacity of power reception of a different electric vehicle serving as the power receiving apparatus.

This makes it possible to, when the electric power of the electric vehicle is supplied to a different electric vehicle serving as the power receiving apparatus, inhibit electric power supplied from the electric vehicle to the different electric vehicle from exceeding the capacity of the different electric vehicle.

A control apparatus according to an aspect of the present disclosure includes a communicator that, in supplying electric power of at least one electric vehicle parked in a facility to an electric power system or at least one power receiving apparatus in the facility, receiving information that a user of the electric vehicle inputted via a terminal and that indicates an SOC at which the user of the electric vehicle wishes for supply of the electric power of the electric vehicle to be stopped and a controller that executes the supply of the electric power of the electric vehicle until the SOC at which the user of the electric vehicle wishes for the supply of the electric power of the electric vehicle to be stopped is reached.

The control apparatus causes the supply of electric power from the electric vehicle to the electric power system or the power receiving apparatus to be stopped when the SOC at which the user of the electric vehicle wishes for the supply of the electric power of the electric vehicle to be stopped is reached.

Accordingly, the control apparatus makes it possible to, in supplying the electric power of the electric vehicle to the electric power system or the power receiving apparatus, inhibit the electric power of the electric vehicle from being supplied until the electric power of the electric vehicle becomes less than an SOC that the user of the electric vehicle wishes.

A specific example of an electric power charge and discharge system according to an aspect of the present disclosure is described below with reference to the drawings. The embodiments shown here illustrate specific examples of the present disclosure. Accordingly, the numerical values, shapes, materials, constituent elements, placement and topology of constituent elements, steps, orders of steps, or other features that are shown in the following embodiments are just a few examples and are not intended to limit the present disclosure. Further, the drawings are schematic views and are not necessarily strict illustrations. In the drawings, components having substantially the same functions are given identical reference signs, and a repeated description is omitted or simplified.

### EMBODIMENT 1

### CONFIGURATION

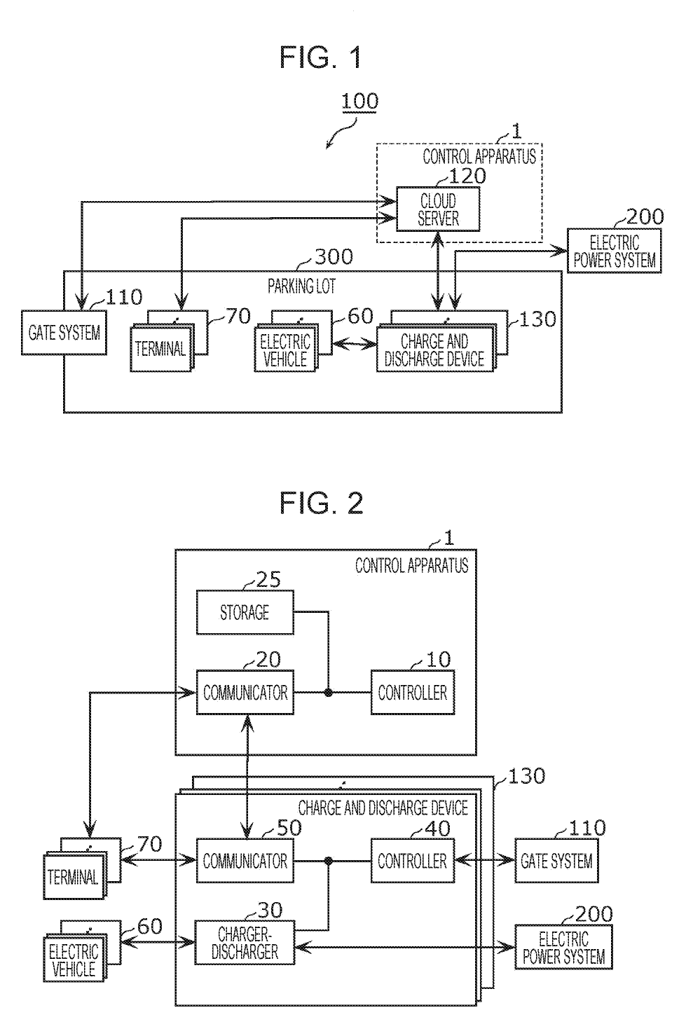

FIG. 1 is a block diagram showing an example of a hardware configuration of an electric power charge and discharge system 100 according to Embodiment 1.

As shown in FIG. 1, the electric power charge and discharge system 100 includes a control apparatus 1, one or more charge and discharge devices 130, a gate system 110, one or more electric vehicles 60, one or more terminals 70, an electric power system 200, and a parking lot 300.

Further, the control apparatus 1 includes a cloud server 120.

The parking lot 300 is a parking space, built in a facility such as an outlet mall, in which a person who uses the facility parks a vehicle that he/she uses.

The gate system 110 is installed at a gateway of the parking lot 300, and performs entry control, exit control, a checkout process, or other processes on a vehicle that enters or exits the parking lot 300.

The electric vehicles 60 are each an electric vehicle parked in the parking lot 300 and are each a vehicle that can be connected to and disconnected from any of the one or more charge and discharge devices 130.

The electric vehicles 60 each include an electric storage device in which to store electric power that is used as a power source and a charging and discharging outlet through which to charge and discharge electric power that is stored in the electric storage device.

The electric power system 200 is an electric power grid of an electric power company that sells and buys electricity to and from the facility in which the parking lot 300 is built.

The charge and discharge devices 130 are each a device, installed in the parking lot 300, that can be attached to and detached from each of the one or more electric vehicles 60 and are each a device for charging electric power into an electric vehicle 60 attached to the charge and discharge device 130 and for causing an electric vehicle 60 attached to the charge and discharge device 130 to discharge electric power.

The charge and discharge devices 130 each include a processor, a memory, and various interfaces and perform various functions by the processor executing a program stored in the memory.

The following description assumes, for example, that the charge and discharge devices 130 are each configured to include one or more connectors that can be connected to the charging and discharging outlet of each of the one or more electric vehicles 60 and one or more conductive cables connected separately to each of the one or more connectors.

The terminals 70 each include an input-output interface and have a function of accepting an input operation from a user who uses the terminal 70 and a function of displaying an image.

The terminals 70 may each be, for example, a terminal that is carried by a user of an electric vehicle 60 and a terminal that can communicate with the control apparatus 1. In this case, the terminals 70 are each, for example, an information terminal such as a smartphone.

The cloud server 120 is a server that can communicate with the gate system 110, the charge and discharge devices 130, and the terminals 70.

The cloud server 120 is implemented, for example, by one or more computer devices each including a processor, a memory, and a communication interface.

FIG. 2 is a block diagram showing an example of a functional configuration of the control apparatus 1 and the charge and discharge devices 130.

In supplying electric power of at least one electric vehicle 60 parked in a facility to the electric power system 200 or at least one power receiving apparatus in the facility, the control apparatus 1 receives information that a user of the electric vehicle 60 inputted via a terminal 70 and that indicates an SOC at which the user of the electric vehicle 60 wishes for supply of the electric power of the electric vehicle 60 to be stopped, and the control apparatus 1 stops the supply of the electric power of the electric vehicle 60 when the SOC at which the user of the electric vehicle 60 wishes for the supply of the electric power of the electric vehicle 60 to be stopped is reached.

The information that indicates the SOC may be information that indicates the SOC per se or may be information that directly indicates the SOC or information that indirectly indicates the SOC. The information that directly indicates the SOC may be an index that indicates the state of charge of a battery or, for example, may be a charging rate expressed as if it is part of a full charge which is 100%. The information that indirectly indicates the SOC may be information that indicates a parameter correlated with the SOC or, for example, may be the amount of supply (amount of discharge) of electric power of the electric vehicle 60.

As shown in FIG. 2, the control apparatus 1 is a cloud server 120 including a controller 10, a communicator 20, and a storage 25.

Further, the one or more charge and discharge devices 130 each include a charger-discharger 30, a controller 40, and a communicator 50.

The charger-discharger 30 has a function of charging electric power supplied from the electric power system 200 via a connector or a conductive cable into an electric vehicle 60 attached to a connector of the charge and discharge device 130 (hereinafter also referred to as "electric vehicle 60 connected to the charger-discharger 30"), a function of discharging, into the electric power system 200, electric power stored by the electric vehicle 60 connected to the charger-discharger 30, a function of discharging, into a different electric vehicle 60 connected to a different charger-discharger 30, electric power stored by the electric vehicle 60 connected to the charger-discharger 30, and a function of charging, into the electric vehicle 60 connected to the charger-discharger 30, electric power discharged from a different electric vehicle 60 connected to a different charger-discharger 30.

The communicator 20 executes communication, for example, by a processor of the controller 10 executing a program stored in a memory within the controller 10.

The communicator 20 receives information that the user of the electric vehicle 60 inputted via the terminal 70 and that indicates an SOC at which the user of the electric vehicle 60 wishes for the supply of the electric power of the electric vehicle 60 to be stopped.

The communicator 20 may be further configured to receive information that the user of the electric vehicle 60 inputted via the terminal 70 and that indicates that the user of the electric vehicle 60 does not allow for a period of time during which the supply of the electric power of the electric vehicle 60 is executed.

The communicator 20 may be further configured to receive information that the user of the electric vehicle 60 inputted via the terminal 70 and that indicates a period of time during which the user of the electric vehicle 60 wishes for the supply of the electric power of the electric vehicle 60 to be executed.

The communicator 20 may be further configured to receive information that the user of the electric vehicle 60 inputted via the terminal 70 and that indicates a current SOC that is a present SOC. In an alternative embodiment, after the charge and discharge device 130 has received, via the communicator 50 from the electric vehicle 60, information that indicates a current SOC, the charge and discharge device 130 may send this information to the communicator 20 via the communicator 50.

The communicator 20 may be further configured to receive information that the user of the electric vehicle 60 inputted via the terminal 70 and that indicates a next destination of the electric vehicle 60.

The communicator 20 may be further configured to receive information that the user of the electric vehicle 60 inputted via the terminal 70 and that indicates a time of departure of the electric vehicle 60.

The controller 10 includes a processor and a memory having stored therein a control program that is executed by the processor.

The controller 10 sends, via the communicator 20 to the charge and discharge device 130 (communicator 50), information that indicates an SOC at which the user of the electric vehicle 60 wishes for the supply of the electric power of the electric vehicle 60 to be stopped.

The controller 40 includes a processor and a memory having stored therein a control program that is executed by the processor.

The communicator 50 executes communication, for example, by the processor of the controller 40 executing the program stored in the memory within the controller 40.

On the basis of the information received via the communicator 50, the controller 40 causes the supply of the electric power of the electric vehicle 60 to be executed until the SOC of a battery mounted in the electric vehicle 60 reaches the SOC at which the user of the electric vehicle 60 wishes for the supply of the electric power of the electric vehicle 60 to be stopped. In other words, the controller 40 causes the supply of the electric power of the electric vehicle 60 to be stopped when the SOC of the battery mounted in the electric vehicle 60 reaches the SOC at which the user of the electric vehicle 60 wishes for the supply of the electric power of the electric vehicle 60 to be stopped. This is an embodiment in which the controller 10 uses the controller 40 to indirectly cause the supply of the electric power of the electric vehicle 60 to be stopped when the SOC at which the user of the electric vehicle 60 wishes for the supply of the electric power of the electric vehicle 60 to be stopped is reached, and is encompassed in the "stopping the supply of the electric power of the electric vehicle when the SOC at which the user of the electric vehicle wishes for the supply of the electric power of the electric vehicle to be stopped is reached" of the present disclosure.

Further, the controller 10 sends, to the terminal 70, information that the controller 10 causes the terminal 70 to display.

When the communicator 20 receives information, inputted by the user of the electric vehicle 60 via the terminal 70, that indicates a period of time during which the user of the electric vehicle 60 wishes for the supply of the electric power of the electric vehicle 60 to be executed, the controller 10 sends, to the charge and discharge device 130 (communicator 50), the information thus received that indicates the period of time during which the user of the electric vehicle 60 wishes for the supply of the electric power of the electric vehicle 60 to be executed.

On the basis of the information received via the communicator 50, the controller 40 may cause the supply of the electric power of the electric vehicle 60 to be executed over the period of time during which the user of the electric vehicle 60 wishes for the supply of the electric power of the electric vehicle 60 to be executed. In other words, the controller 40 may cause the supply of the electric power of the electric vehicle 60 to be stopped when the period of time during which the supply of the electric power of the electric vehicle 60 is executed reaches the period of time during which the user of the electric vehicle 60 wishes for the supply of the electric power of the electric vehicle 60 to be executed. This is an embodiment in which the controller 10 uses the controller 40 to indirectly cause the supply of the electric power of the electric vehicle 60 to be stopped when a point of time at which the user of the electric vehicle 60 wishes for the supply of the electric power of the electric vehicle 60 to be stopped is reached.

Further, the controller 10 determines supply power from the electric vehicle 60 so that the supply power from the electric vehicle 60 does not exceed an amount of electricity demanded by a different electric vehicle 60 serving as the power receiving apparatus in the facility, and sends, to the charge and discharge device 130 (communicator 50), information that indicates the supply power from the electric vehicle 60 thus determined.

On the basis of the information received via the communicator 50, the controller 40 controls the charger-discharger 30 to adjust the supply power from the electric vehicle 60. This is an embodiment in which the controller 10 uses the controller 40 to indirectly adjust the supply power from the electric vehicle 60 so that the supply power from the electric vehicle 60 does not exceed an amount of electricity demanded by a different electric vehicle 60 serving as the power receiving apparatus in the facility, and is encompassed in the clause "supply power from the electric vehicle is adjusted so as not to exceed an amount of electricity demanded by a different electric vehicle serving as the power receiving apparatus" of the present disclosure.

The controller 10 calculates, on the basis of received information that the communicator 20 received and that indicates the SOC at which the user of the electric vehicle 60 wishes for the supply of the electric power of the electric vehicle to be stopped, a period of time during which the supply of the electric power of the electric vehicle 60 is executed.

Upon determining that the SOC at which the user of the electric vehicle 60 wishes for the supply of the electric power of the electric vehicle 60 to be stopped is less than an SOC needed for the electric vehicle 60 to arrive at a destination from the facility, the controller 10 sends, via the communicator 20 to the terminal 70, an error message or a message that suggests modifying the SOC at which the user of the electric vehicle 60 wishes for the supply of the electric power of the electric vehicle 60 to be stopped. At the terminal 70, a controller (not illustrated) causes a display (not illustrated) of the terminal 70 to display at least either of these messages. This is an embodiment in which the controller 10 uses the controller of the terminal 70 to indirectly cause the terminal 70 to display an error message or a message that suggests modifying the SOC at which the user of the electric vehicle 60 wishes for the supply of the electric power of the electric vehicle 60 to be stopped. Accordingly, this embodiment is encompassed in the clause "when the SOC at which the user of the electric vehicle wishes for the supply of the electric power of the electric vehicle to be stopped is less than an SOC needed for the electric vehicle to arrive at a destination from the facility, an error message or a message that suggests modifying the SOC at which the user of the electric vehicle wishes for the supply of the electric power of the electric vehicle to be stopped is displayed on a screen of the terminal" of the present disclosure.

Information that indicates the destination may be inputted to the terminal 70 by the user of the electric vehicle 60, sent by the terminal 70, received by the communicator 20, and stored in the storage 25. In this case, the information that indicates the destination may be associated with identification information of the terminal 70, identification information of the user, or identification information of the electric vehicle 60 and stored in the storage 25.

Alternatively, information pertaining to the destination may be inputted by the user of the electric vehicle 60 to a drive assist device, such as a car navigation device, provided in the electric vehicle 60, be sent by the drive assist device, be received by the communicator 20, and be stored in the storage 25. In this case, the information that indicates the destination may be associated with identification information of the drive assist device, identification information of the user, or identification information of the electric vehicle 60 and stored in the storage 25.

Further, upon determining that a capacity of an electric storage device serving as the power receiving apparatus in the facility is exceeded when the electric power of the electric vehicle 60 is supplied to the electric storage device until the SOC of the battery mounted in the electric vehicle 60 reaches the SOC at which the user of the electric vehicle 60 wishes for the supply of the electric power of the electric vehicle 60 to be stopped, the controller 10 sends, via the communicator 20 to the terminal 70, an error message or a message that suggests modifying the SOC at which the user of the electric vehicle 60 wishes for the supply of the electric power of the electric vehicle 60 to be stopped. At the terminal 70, the controller of the terminal 70 may cause the display of the terminal 70 to display at least either of these messages. This is an embodiment in which the controller 10 uses the controller of the terminal 70 to indirectly cause the display of the terminal 70 to display an error message or a message that suggests modifying the SOC at which the user of the electric vehicle 60 wishes for the supply of the electric power of the electric vehicle 60 to be stopped. Accordingly, this embodiment is encompassed in the clause "when a capacity of an electric storage device serving as the power receiving apparatus is exceeded when the electric power of the electric vehicle is supplied to the electric storage device until the SOC at which the user of the electric vehicle wishes for the supply of the electric power of the electric vehicle to be stopped is reached, an error message or a message that suggests modifying the SOC at which the user of the electric vehicle wishes for the supply of the electric power of the electric vehicle to be stopped is displayed on a screen of the terminal" of the present disclosure.

Information pertaining to the capacity of the electric storage device is stored in the storage 25, and information that indicates the SOC of the electric storage device may be received by the communicator 20 via a communicator (not illustrated) provided in the electric storage device and be stored in the storage 25.

Further, upon determining that a power purchase demand of the electric power system 200 is exceeded when the electric power of the electric vehicle 60 is supplied to the electric power system 200 until the SOC of the battery mounted in the electric vehicle 60 reaches the SOC at which the user of the electric vehicle 60 wishes for the supply of the electric power of the electric vehicle 60 to be stopped, the controller 10 sends, via the communicator 20 to the terminal 70, an error message or a message that suggests modifying the SOC at which the user of the electric vehicle 60 wishes for the supply of the electric power of the electric vehicle 60 to be stopped. At the terminal 70, the controller of the terminal 70 may cause the display of the terminal 70 to display at least either of these messages. Information that indicates the power purchase demand of the electric power system 200 may be received as appropriate from an aggregator via the communicator 20 and stored in the storage 25. This is an embodiment in which the controller 10 uses the controller of the terminal 70 to indirectly cause the display of the terminal 70 to display an error message or a message that suggests modifying the SOC at which the user of the electric vehicle 60 wishes for the supply of the electric power of the electric vehicle 60 to be stopped. Accordingly, this embodiment is encompassed in the clause "when a power purchase demand of the electric power system is exceeded when the electric power of the electric vehicle is supplied to the electric power system until the SOC at which the user of the electric vehicle wishes for the supply of the electric power of the electric vehicle to be stopped is reached, an error message or a message that suggests modifying the SOC at which the user of the electric vehicle wishes for the supply of the electric power of the electric vehicle to be stopped is displayed on a screen of the terminal" of the present disclosure.

When the discharge power per unit time with which the electric power stored in the electric vehicle 60 is discharged into the electric power system 200 is not rated but variable, the controller 10 may determine discharge power per unit time that is lower than rated discharge power per unit time that does not exceed the power purchase demand of the electric power system 200 and send the discharge power thus determined to the charge and discharge device 130 (communicator 50) via the communicator 20. The controller 40 controls the charger-discharger 30 to discharge the electric power from the electric vehicle 60 into the electric power system 200 with the discharge power received via the communicator 50. This makes it possible to discharge the electric power stored in the electric vehicle 60 into the electric power system 200 so that the power purchase demand of the electric power system 200 is not exceeded. This is an embodiment in which the controller 10 uses the controller 40 to indirectly adjust the supply of the electric power from the electric vehicle 60 to the electric power system 200 so that the power purchase demand of the electric power system 200 is not exceeded.

Further, the controller 10 may calculate, on the basis of information that indicates the SOC at which the user of the electric vehicle 60 wishes for the supply of the electric power of the electric vehicle 60 to be stopped, a period of time during which the supply of the electric power of the electric vehicle 60 is executed and send, via the communicator 20 to the terminal 70, information that indicates the period of time. At the terminal 70, the controller of the terminal 70 may cause the display of the terminal 70 to display the information that indicates the period of time thus calculated. This is an embodiment in which the controller 10 uses the controller of the terminal 70 to indirectly cause the display of the terminal 70 to display the information that indicates the period of time thus calculated. Accordingly, this embodiment is encompassed in the "calculating, on the basis of received information that indicates the SOC at which the user of the electric vehicle wishes for the supply of the electric power of the electric vehicle to be stopped, a period of time during which the supply of the electric power of the electric vehicle is executed and displaying, on a screen of the terminal, information that indicates the period of time thus calculated" of the present disclosure.

Further, the controller 10 may send, via the communicator 20 to the terminal 70, information that checks with the user of the electric vehicle 60 whether the user of the electric vehicle 60 allows for a period of time during which the supply of the electric power of the electric vehicle 60 is executed. At the terminal 70, the controller of the terminal 70 may cause the display of the terminal 70 to display the information that checks with the aforementioned user. This is an embodiment in which the controller 10 uses the controller of the terminal 70 to indirectly cause the display of the terminal 70 to display the information that checks with the aforementioned user. Accordingly, this embodiment is encompassed in the "causing the terminal to display information that checks with the user of the electric vehicle whether the user of the electric vehicle allows for a period of time during which the supply of the electric power of the electric vehicle is executed" of the present disclosure.

Further, when the communicator 20 receives information that indicates that the user of the electric vehicle 60 does not allow for a period of time during which the supply of the electric power of the electric vehicle 60 is executed, the controller 10 may send, via the communicator 20 to the terminal 70, information that prompts inputting of information that indicates a period of time during which the user of the electric vehicle 60 wishes for the supply of the electric power of the electric vehicle 60 to be executed. At the terminal 70, the controller of the terminal 70 may cause the display of the terminal 70 to display the information that prompts the aforementioned inputting. This is an embodiment in which the controller 10 uses the controller of the terminal 70 to indirectly cause the display of the terminal 70 to display the information that prompts the aforementioned inputting. Accordingly, this embodiment is encompassed in the "upon receiving the information that indicates that the user of the electric vehicle does not allow for a period of time during which the supply of the electric power of the electric vehicle is executed, causing the terminal to display information that prompts inputting of information that indicates a period of time during which the user of the electric vehicle wishes for the supply of the electric power of the electric vehicle to be executed" of the present disclosure.

Further, the controller 10 may send, to the terminal 70, information that indicates a lower-limit value of an SOC that the user of the electric vehicle inputs via the terminal 70 and at which the user of the electric vehicle 60 wishes for the supply of the electric power of the electric vehicle 60 to be stopped. At the terminal 70, the controller of the terminal 70 may cause the display of the terminal 70 to display the information that indicates the lower-limit value of the aforementioned SOC. In this case, the lower-limit value is set by the controller 10 to such a value as not to exceed a capacity of power reception of a different electric vehicle 60 serving as the power receiving apparatus in the facility. This is an embodiment in which the controller 10 uses the controller of the terminal 70 to indirectly cause the display of the terminal 70 to display the information that indicates the lower-limit value of the aforementioned SOC. Accordingly, this embodiment is encompassed in the "causing the terminal to display a lower-limit value of an SOC that the user of the electric vehicle inputs via the terminal and at which the user of the electric vehicle wishes for the supply of the electric power of the electric vehicle to be stopped" of the present disclosure.

The capacity of power reception of the different electric vehicle 60 is the difference between the full-charge capacity of the different electric vehicle 60 and the present SOC of the different electric vehicle 60 and is calculated by the controller 10. Information that indicates the full-charge capacity of the different electric vehicle 60 and information that indicates the present SOC of the different electric vehicle 60 are sent from the different electric vehicle 60 or a charge and discharge device 130 connected to the different electric vehicle 60, received via the communicator 20, and stored in the storage 25.

Further, when the SOC at which the user of the electric vehicle 60 wishes for the supply of the electric power of the electric vehicle 60 to be stopped is not less than the present SOC of the electric vehicle 60, the controller 10 may send, via the communicator 20 to the terminal 70, an error message or a message that suggests modifying the SOC at which the user of the electric vehicle 60 wishes for the supply of the electric power of the electric vehicle 60 to be stopped. At the terminal 70, the controller of the terminal 70 may cause the display of the terminal 70 to display at least either of these messages. This is an embodiment in which the controller 10 uses the controller of the terminal 70 to indirectly cause the display of the terminal 70 to display an error message or a message that suggests modifying the SOC at which the user of the electric vehicle 60 wishes for the supply of the electric power of the electric vehicle 60 to be stopped.

When the user of the electric vehicle 60 judges that the discharge of the electric vehicle 60 is not completed by the time of departure of the electric vehicle 60 with the SOC at which the user of the electric vehicle 60 wishes for the supply of the electric power of the electric vehicle 60 to be stopped, the controller 10 may send, via the communicator 20 to the terminal 70, an error message or a message that suggests modifying the SOC at which the user of the electric vehicle 60 wishes for the supply of the electric power of the electric vehicle 60 to be stopped. At the terminal 70, the controller of the terminal 70 may cause the display of the terminal 70 to display at least either of these messages. This is an embodiment in which the controller 10 uses the controller of the terminal 70 to indirectly cause the display of the terminal 70 to display an error message or a message that suggests modifying the SOC at which the user of the electric vehicle 60 wishes for the supply of the electric power of the electric vehicle 60 to be stopped.

### Operation

The following describes an operation that is performed by the electric power charge and discharge system 100 thus configured.

In addition to executing an electric power charge process of charging, into an electric vehicle 60 connected to a charger-discharger 30, electric power supplied from the electric power system 200, the electric power charge and discharge system 100 executes a first electric power discharge process of supplying, to the electric power system 200 or at least one power receiving apparatus in the facility, electric power stored in an electric vehicle 60 connected to a charger-discharger 30.

The following describes the first electric power discharge process that is performed by the electric power charge and discharge system 100.

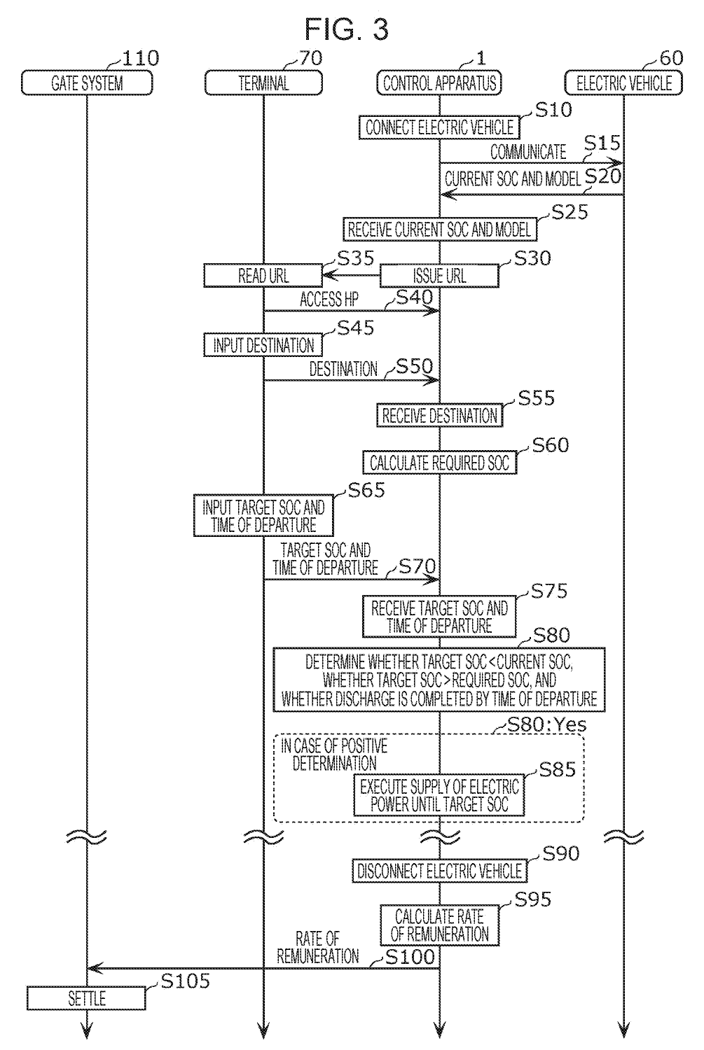

FIG. 3 is a sequence diagram of the first electric power discharge process that is performed by the electric power charge and discharge system 100.

A user who uses an electric vehicle 60 connects the electric vehicle 60 to a charge and discharge device 130, then as shown in FIG. 3, the electric vehicle 60 starts communication with the communicator 20 of the control apparatus 1 (step S15) and sends information that indicates a current SOC that is a present SOC and information that indicates the model of the electric vehicle 60 (step S20). Then, the communicator 20 receives, from the electric vehicle 60, the information that indicates the current SOC and the information that indicates the model of the electric vehicle 60 (step S25). Alternatively, an embodiment such as the aforementioned one in which the information that indicates the current SOC and the information that indicates the model are directly sent from the electric vehicle 60 may be replaced by an embodiment in which these pieces of information are sent from the electric vehicle 60 to the charge and discharge device 130 and then sent from the charge and discharge device 130 to the control apparatus 1 via the communicator 50.

Next, the control apparatus 1 sends to a terminal 70, information that indicates a URL for accessing a homepage for charger-discharger users (step S30) and thereby issues the URL to the user who uses the electric vehicle 60.

The user who uses the electric vehicle 60 selects the URL displayed on a screen of the terminal 70 (step S35) and accesses the homepage for charger-discharger users (step S40). Alternatively, the embodiment in which the information that indicates the URL is sent to the terminal 70 may be replaced by an embodiment in which the information that indicates the URL is sent to the charge and discharge device 130 and the terminal 70 receives, from the charge and discharge device 130, the information that indicates the URL. For example, in an alternative embodiment, a two-dimensional bar code that indicates the URL may be sent to the charge and discharge device 130, displayed on a display (not illustrated) provided in the charge and discharge device 130, and read by the terminal 70.

Moreover, the user who uses the electric vehicle 60 operates the terminal 70 to input a next destination of the electric vehicle 60 on the homepage for charger-discharger users (step S45). Then, the terminal 70 sends, to the control apparatus 1, information that indicates the destination (step S50), and the communicator 20 receives, from the terminal 70, the information that indicates the destination (step S55).

When the communicator 20 receives the information that indicates the destination, the controller 10 calculates, on the basis of the next destination of the electric vehicle 60 and the model of the electric vehicle 60, a required SOC that is an SOC needed for the electric vehicle 60 to arrive at the next destination (step S60).

Meanwhile, the user who uses the electric vehicle 60 operates the terminal 70 to input, on the homepage for charger-discharger users, a target SOC that is an SOC at which the user who uses the electric vehicle 60 wishes for the supply of the electric power of the electric vehicle 60 to be stopped and the time of departure of the electric vehicle 60 (step S65). Then, the terminal 70 sends, to the control apparatus 1, information that indicates the target SOC and information that indicates the time of departure (step S70), and the communicator 20 receives, from the terminal 70, the information that indicates the target SOC and the information that indicates the time of departure (step S75). In the process of step S65, instead of inputting the time of departure, the user of the electric vehicle 60 may input a length of time during which the user of the electric vehicle 60 can stay in the facility.

When the communicator 20 receives the information that indicates the target SOC and the information that indicates the time of departure, the controller 10 determines (1) whether the target SOC is less than the current SOC, (2) whether the target SOC is greater than the required SOC, and (3) whether the discharge is completed by the time of departure (step S80; this step being hereinafter also referred to as "discharge start condition determination"). Although all of (1) to (3) are used as conditions for determination, this is not intended to impose any limitation. At least one of (1) to (3) may be used as a condition for determination.

When a result of the discharge start condition determination is positive (step S80; Yes), the controller 10 sends, to the terminal 70, information that indicates that the result of the determination is positive, and this information is displayed on the screen of the terminal 70. After the user of the electric vehicle 60 has confirmed this information, a discharge instruction is given from the user of the electric vehicle 60. The discharge instruction is started, for example, by the user who uses the electric vehicle 60 performing an operation of instructing the charge and discharge device 130 or the terminal 70 to start the discharge of the electric vehicle 60. When the operation is performed on the charge and discharge device 130, the user performs the operation via an inputter (not illustrated) provided in the charge and discharge device 130. When the operation is performed on the terminal 70, the discharge instruction based on this operation is sent to the control apparatus 1 (communicator 20), and this instruction thus received is sent by the controller 10 to the charge and discharge device 130 via the communicator 20.

Meanwhile, when the result of the discharge start condition determination is positive (step S80; Yes), the controller 10 sends, to the charge and discharge device 130, the information that indicates the target SOC.

] Accordingly, in accordance with the discharge instruction given by the user of the electric vehicle 60, the controller 40 of the charge and discharge device 130 controls the charger-discharger 30 to cause the charger-discharger 30 to execute the supply of the electric power of the electric vehicle 60 until the SOC of the battery mounted in the electric vehicle 60 reaches the SOC at which the user of the electric vehicle 60 wishes for the supply of the electric power of the electric vehicle 60 to be stopped (step S85). Although, in the foregoing, when the result of the discharge start condition determination is positive (step S80; Yes), the controller 10 sends, to the terminal 70, the information that indicates that the result of the determination is positive, the controller 10 may not send the information. In this case, the supply of the electric power of the electric vehicle 60 is started by the controller 10 sending, to the charge and discharge device 130, not only the information that indicates the target SOC but also the discharge instruction. Alternatively, it is possible to execute step S85 without executing step S80. In this case, the supply of the electric power of the electric vehicle 60 is started by the controller 10 sending, to the charge and discharge device 130, not only the information that indicates the target SOC but also the discharge instruction.

The controller 10 does not perform the process of step S85 when the result of the discharge start condition determination is negative.

After that, when the time of departure comes, the user who uses the electric vehicle 60 disconnects the electric vehicle 60 from the charger-discharger 30 (step S90). Then, the controller 10 calculates, according to electric power supplied from the electric vehicle 60, a rate of remuneration that the user who uses the electric vehicle 60 is paid in compensation for the electric power (step S95). Moreover, the controller 10 sends, via the communicator 20 to the gate system 110, information that indicates the rate of remuneration thus calculated (step S100), and the gate system 110 receives, from the control apparatus 1, the information that indicates the rate of remuneration.

After that, when the electric vehicle 60 arrives at the gate system 110 to go out of the parking lot 300, the gate system 110 settles, on the basis of a parking lot usage fee for use of the parking lot 300 by the electric vehicle 60 and the information received from the control apparatus 1 that indicates the rate of remuneration and with the user who uses the electric vehicle 60, the amount of money that is to be paid to or received from the user (step S105).

Upon completion of the process of step S105, the first electric power discharge process ends.

In the aforementioned first electric power discharge process, after the end of the process of step S75, at least one of the after-mentioned first message A display process, first message B display process, first message C display process, first message D display process, first message E display process, and first message FG display process may be performed in addition to or in place of the process of step S80.

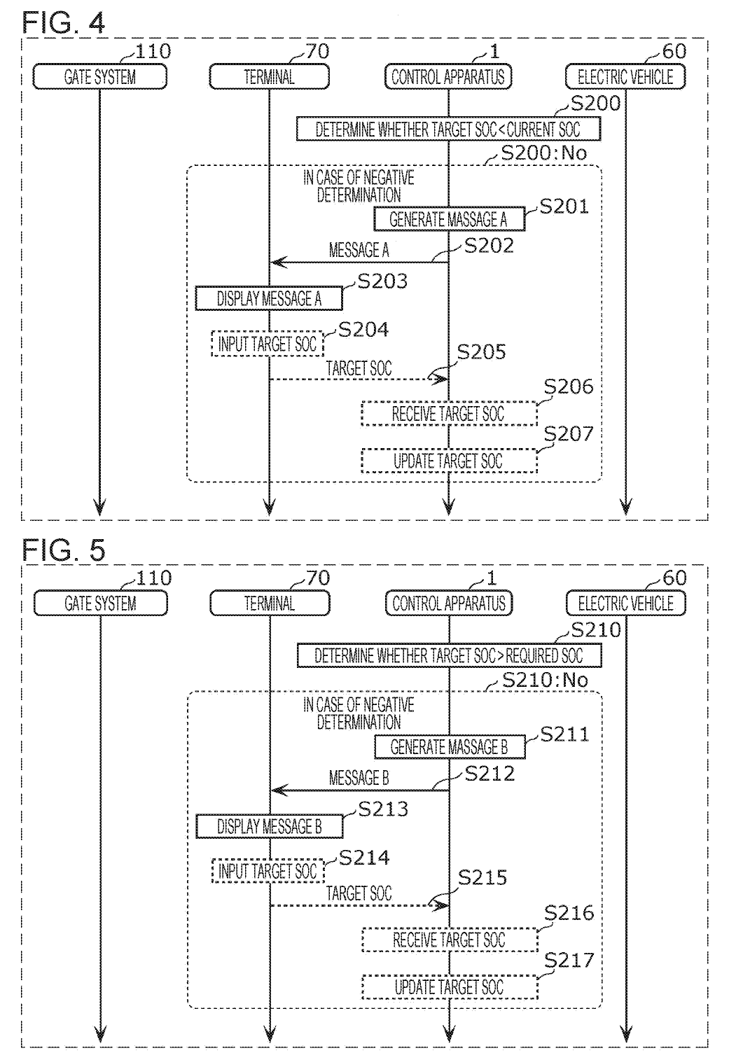

FIG. 4 is a sequence diagram of the first message A display process.

The first message A display process is started, for example, by ending the process of step S75 in the first electric power discharge process.

When the first message A display process is started, the controller 10 determines whether the target SOC is less than the current SOC (step S200).

When the result of the determination is negative (step S200; No), the controller 10 generates an error message or a message (hereinafter also referred to as "message A") that suggests modifying the target SOC(step S201), and sends the message A thus generated to the terminal 70 via the communicator 20 (step S202). At the terminal 70, the controller of the terminal 70 causes the display of the terminal 70 to display the message A (step S203).

When the user who uses the electric vehicle 60 has confirmed the message A displayed on the display of the terminal 70 and operates the terminal 70 to input a new target SOC on the homepage for charger-discharger users (step S204), the terminal 70 sends, to the control apparatus 1, information that indicates the new target SOC inputted to the terminal 70 (step S205). Then, the communicator 20 receives, from the terminal 70, the information that indicates the new SOC (step S206), and when the target SOC thus received satisfies step S200, the target SOC is updated with the new target SOC thus received (step S207).

When the determination made in the process of step S200 is positive or upon completion of the process of step S207, the first message A display process ends. When the first message A display process is executed after or in place of step S80, a process that follows the time when the result of the determination made in step S80 is positive is executed after the time when the determination made in the process of step S200 is positive or after the process of step S207.

FIG. 5 is a sequence diagram of the first message B display process.

The first message B display process is started, for example, by ending the process of step S75 in the first electric power discharge process.

When the first message B display process is started, the controller 10 determines whether the target SOC is greater than the required SOC (step S210).

When the result of the determination is negative (step S210; No), the controller 10 generates an error message or a message (hereinafter also referred to as "message B") that suggests modifying the target SOC(step S211), and sends the message B thus generated to the terminal 70 via the communicator 20 (step S212). At the terminal 70, the controller of the terminal 70 causes the display of the terminal 70 to display the message B (step S213).

When the user who uses the electric vehicle 60 has confirmed the message B displayed on the display of the terminal 70 and operates the terminal 70 to input a new target SOC on the homepage for charger-discharger users (step S214), the terminal 70 sends, to the control apparatus 1, information that indicates the new target SOC inputted to the terminal 70 (step S215). Then, the communicator 20 receives from the terminal 70, the information that indicates the new SOC (step S216), and when the target SOC thus received satisfies step S210, the target SOC is updated with the new target SOC thus received (step S217).

When the determination made in the process of step S210 is positive or upon completion of the process of step S217, the first message B display process ends. When the first message B display process is executed after or in place of step S80, a process that follows the time when the result of the determination made in step S80 is positive is executed after the time when the determination made in the process of step S210 is positive or after the process of step S217.

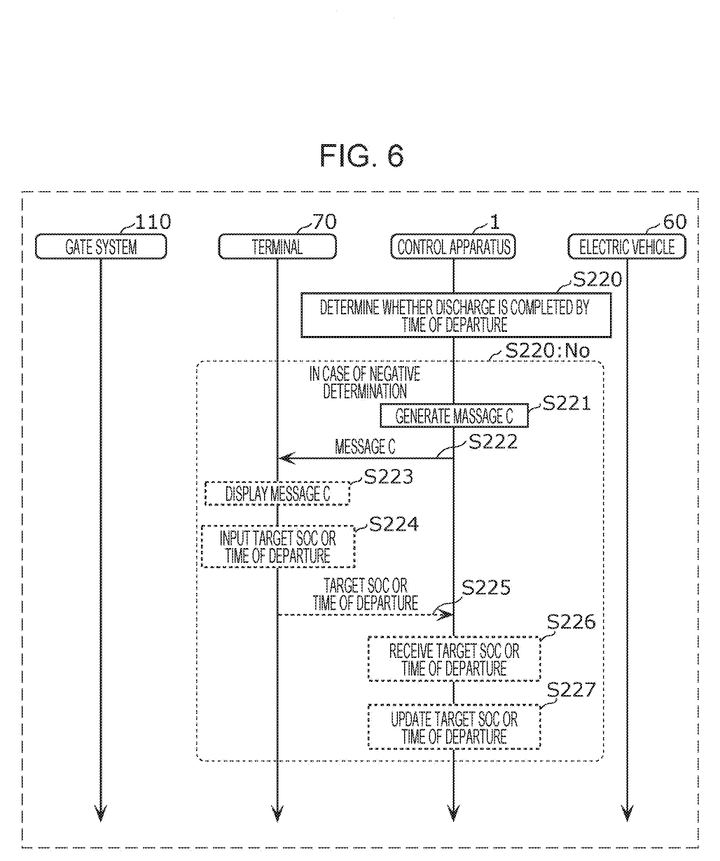

FIG. 6 is a sequence diagram of the first message C display process.

The first message C display process is started, for example, by ending the process of step S75 in the first electric power discharge process.

When the first message C display process is started, the controller 10 determines whether the discharge is completed by the time of departure (step S220).

When the result of the determination is negative (step S220; No), the controller 10 generates an error message, a message that suggests modifying the target SOC, or a message (hereinafter also referred to as "message C") that suggests modifying the time of departure (step S221), and sends the message C thus generated to the terminal 70 via the communicator 20 (step S222). At the terminal 70, the controller of the terminal 70 causes the display of the terminal 70 to display the message C (step S223).

When the user who uses the electric vehicle 60 has confirmed the message C displayed on the display of the terminal 70 and operates the terminal 70 to input a new target SOC or a new time of departure on the homepage for charger-discharger users (step S224), the terminal 70 sends, to the control apparatus 1, information that indicates the new target SOC inputted to the terminal 70 or information that indicates the new time of departure inputted to the terminal 70 (step S225). Then, the communicator 20 receives, from the terminal 70, the information that indicates the new SOC or the information that indicates the new time of departure (step S226), and when the new target SOC thus received or the new time of departure thus received satisfies step S220, the target SOC is updated with the new target SOC thus received or the time of departure is updated with the new time of departure thus received (step S227).

When the determination made in the process of step S220 is positive or upon completion of the process of step S227, the first message C display process ends. When the first message C display process is executed after or in place of step S80, a process that follows the time when the result of the determination made in step S80 is positive is executed after the time when the determination made in the process of step S220 is positive or after the process of step S227. In the present process, the time of departure may be replaced by the length of time during which the user of the electric vehicle 60 stays in the facility.

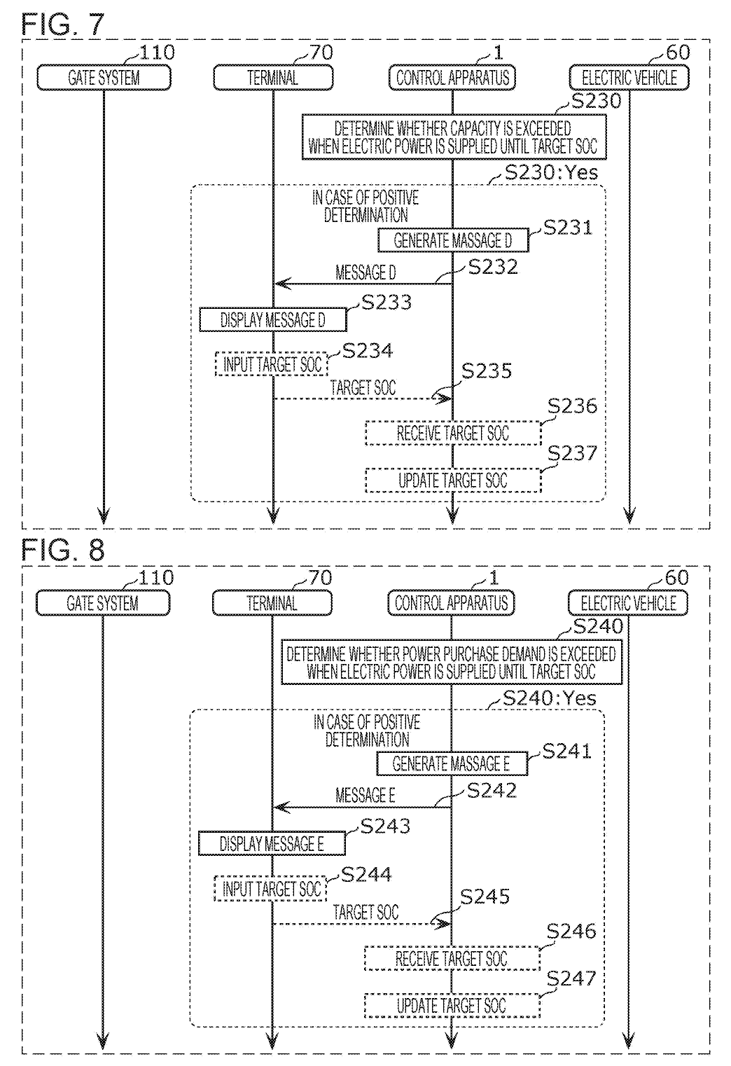

FIG. 7 is a sequence diagram of the first message D display process.

The first message D display process is started, for example, by ending the process of step S75 in the first electric power discharge process.

When the first message D display process is started, the controller 10 determines whether a capacity of an electric storage device serving as the power receiving apparatus is exceeded when the electric power of the electric vehicle 60 is supplied to the electric storage device until the target SOC is reached (step S230).

When the result of the determination is positive (step S230; Yes), the controller 10 generates an error message or a message (hereinafter also referred to as "message D") that suggests modifying the target SOC(step S231), and sends the message D thus generated to the terminal 70 via the communicator 20 (step S232). At the terminal 70, the controller of the terminal 70 causes the display of the terminal 70 to display the message D (step S233).

When the user who uses the electric vehicle 60 has confirmed the message D displayed on the display of the terminal 70 and operates the terminal 70 to input a new target SOC on the homepage for charger-discharger users (step S234), the terminal 70 sends, to the control apparatus 1, information that indicates the new target SOC inputted to the terminal 70 (step S235). Then, the communicator 20 receives from the terminal 70, the information that indicates the new SOC (step S236), and when the target SOC thus received satisfies step S230, the target SOC is updated with the new target SOC thus received (step S237).

When the determination made in the process of step S230 is negative or upon completion of the process of step S237, the first message D display process ends. When the first message D display process is executed after or in place of step S80, a process that follows the time when the result of the determination made in step S80 is positive is executed after the time when the determination made in the process of step S230 is positive or after the process of step S237.

FIG. 8 is a sequence diagram of the first message E display process.

The first message E display process is started, for example, by ending the process of step S75 in the first electric power discharge process.

When the first message E display process is started, the controller 10 determines whether the power purchase demand of the electric power system 200 is exceeded when the electric power of the electric vehicle 60 is supplied to the electric power system 200 until the target SOC is reached (step S240).

When the result of the determination is positive (step S240; Yes), the controller 10 generates an error message or a message (hereinafter also referred to as "message E") that suggests modifying the target SOC(step S241), and sends the message E thus generated to the terminal 70 via the communicator 20 (step S242). At the terminal 70, the controller of the terminal 70 causes the display of the terminal 70 to display the message E (step S243).

When the user who uses the electric vehicle 60 has confirmed the message E displayed on the display of the terminal 70 and operates the terminal 70 to input a new target SOC on the homepage for charger-discharger users (step S244), the terminal 70 sends, to the control apparatus 1, information that indicates the new target SOC inputted to the terminal 70 (step S245). Then, the communicator 20 receives, from the terminal 70, the information that indicates the new SOC (step S246), and when the target SOC thus received satisfies step S240, the target SOC is updated with the new target SOC thus received (step S247).

When the determination made in the process of step S240 is negative or upon completion of the process of step S247, the first message E display process ends. When the first message E display process is executed after or in place of step S80, a process that follows the time when the result of the determination made in step S80 is positive is executed after the time when the determination made in the process of step S240 is positive or after the process of step S247.

FIG. 9 is a sequence diagram of the first message FG display process.

The first message FG display process is started, for example, by ending the process of step S75 in the first electric power discharge process.

When the first message FG display process is started, the controller 10 calculates, on the basis of the target SOC, a period of charge execution time that is a period of time during which the supply of the electric power of the electric vehicle 60 is executed (step S250). Then, the controller 10 sends, via the communicator 20 to the terminal 70, information that indicates the period of charge execution thus calculated (step S251). At the terminal 70, the controller of the terminal 70 causes the display of the terminal 70 to display the information that indicates the period of charge execution (step S252).

Further, the controller 10 generates a message (hereinafter also referred to as "message F") that checks with the user of the electric vehicle 60 whether the user of the electric vehicle 60 allows for the period of charge execution (step S253), and sends the message F thus generated to the terminal 70 via the communicator 20 (step S254). At the terminal 70, the controller of the terminal 70 causes the display of the terminal 70 to display the message F (step S255).

When the user who uses the electric vehicle 60 has confirmed the message F displayed on the display of the terminal 70 and operates the terminal 70 to perform input on the homepage for charger-discharger users to the effect that the user who uses the electric vehicle 60 does not allow for the period of charge execution (step S256), the terminal 70 sends, to the control apparatus 1, information that indicates that the user who uses the electric vehicle 60 does not allow for the period of charge execution (step S257). Then, the communicator 20 receives, from the terminal 70, the information that indicates that the user who uses the electric vehicle 60 does not allow for the period of charge execution (step S258), and the controller 10 generates a message (hereinafter referred to as "message G") that prompts inputting of information that indicates a desired period of supply that is a period of time during which the user of the electric vehicle 60 wishes for the supply of the electric power of the electric vehicle 60 to be executed (step S259), and sends the message G thus generated to the terminal 70 via the communicator 20 (step S260). At the terminal 70, the controller of the terminal 70 causes the display of the terminal 70 to display the message G (step S261).

When the user who uses the electric vehicle 60 has confirmed the message G displayed on the display of the terminal 70 and operates the terminal 70 to input the desired period of supply on the homepage for charger-discharger users (step S262), the terminal 70 sends, to the control apparatus 1, information that indicates the desired period of supply inputted to the terminal 70 (step S263). Then, the communicator 20 receives from the terminal 70, the information that indicates the desired period of supply (step S264).

When the user of the electric vehicle 60 has performed input in the process of step S256 to the effect that the user of the electric vehicle 60 allows for the period of charge execution or upon completion of the process of step S264, the first message FG display process ends.

When the user of the electric vehicle 60 has performed input in the process of step S256 to the effect that the user of the electric vehicle 60 allows for the period of charge execution or when the process of step S85 of the first electric power discharge process is executed when the process of step S264 has been executed, the controller 10 causes the supply of the electric power of the electric vehicle 60 to be executed over the desired period of supply in the process of step S85. In other words, the supply of the electric power of the electric vehicle 60 is stopped when the desired period of supply elapses.

Furthermore, prior to the start of the process of step S65 in the first electric power discharge process, the after-mentioned first message H display process may be performed in addition to or in place of the process of step S60.

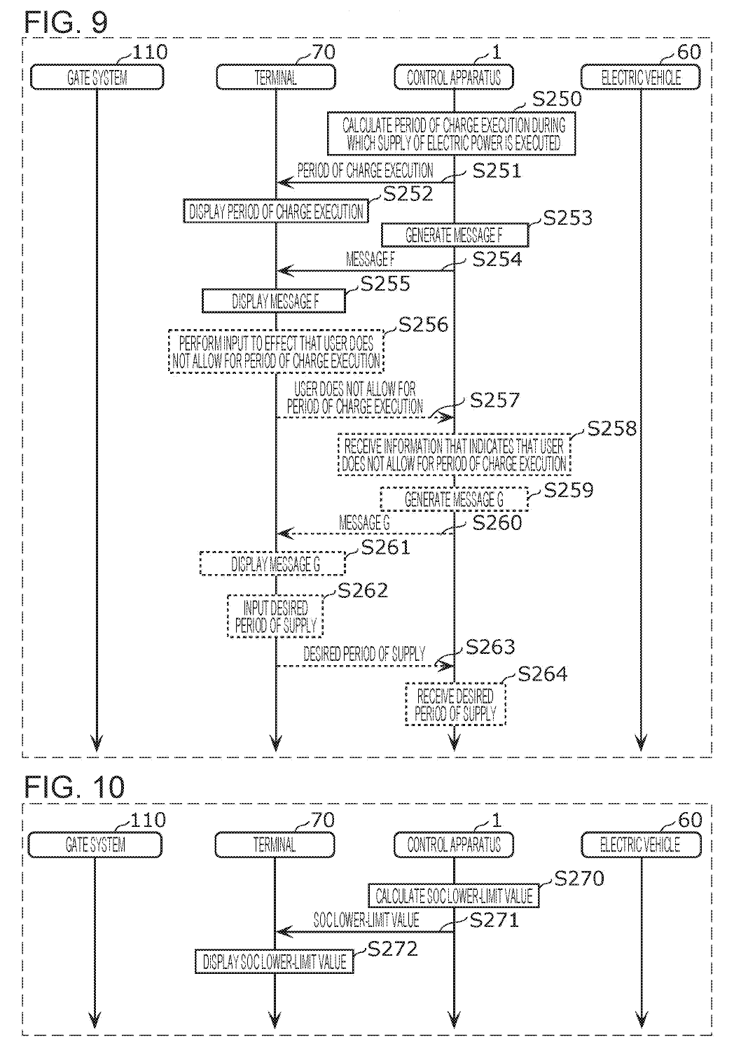

FIG. 10 is a sequence diagram of the first message H display process.

The first message H display process is started, for example, by ending the process of step S60 in the first electric power discharge process.

When the first message H display process is started, the controller 10 calculates an SOC lower-limit value that is such a value as not to exceed a capacity of power reception of a different electric vehicle 60 connected to a different charger-discharger 30 and serving as the power receiving apparatus in the facility (step S270) and sends, to the terminal 70, information that indicates the SOC lower-limit value thus calculated (step S271). At the terminal 70, the controller of the terminal 70 causes the display of the terminal 70 to display the information that indicates the SOC lower-limit value thus calculated (step S272). This allows the user of the electric vehicle 60 to input the target SOC in the process of step S65 of the first electric power discharge process with reference to the SOC lower-limit value displayed on the terminal 70.

Upon completion of the process of step S272, the first message H display process ends.

### Discussion

The control apparatus 1 thus configured causes the supply of electric power from the electric vehicle 60 to the electric power system 200 or the power receiving apparatus to be stopped when the SOC at which the user of the electric vehicle 60 wishes for the supply of the electric power of the electric vehicle 60 to be stopped is reached.

Accordingly, the control apparatus 1 thus configured makes it possible to, in supplying the electric power of the electric vehicle 60 to the electric power system 200 or the power receiving apparatus, inhibit the electric power of the electric vehicle 60 from being supplied until the electric power of the electric vehicle 60 becomes less than an SOC that the user of the electric vehicle 60 wishes.

### Embodiment 2

The following describes an electric power charge and discharge system according to Embodiment 2 that is partly different in configuration from the electric power charge and discharge system 100 according to Embodiment 1.

The electric power charge and discharge system 100 according to Embodiment 1 is an example of being configured to include one or more terminals 70. On the other hand, the electric power charge and discharge system according to Embodiment 2 is an example of a configuration in which instead of including one or more terminals 70, a charge and discharge device according to Embodiment 2 includes an input-output terminal including an input function and a display function.

Constituent elements of the electric power charge and discharge system according to Embodiment 2 that are similar to those of the electric power charge and discharge system 100 are given the same reference signs as having been already described. A detailed description of such constituent elements is omitted. The electric power charge and discharge system according to Embodiment 2 is described with a focus on points of difference from the electric power charge and discharge system 100.

### Configuration

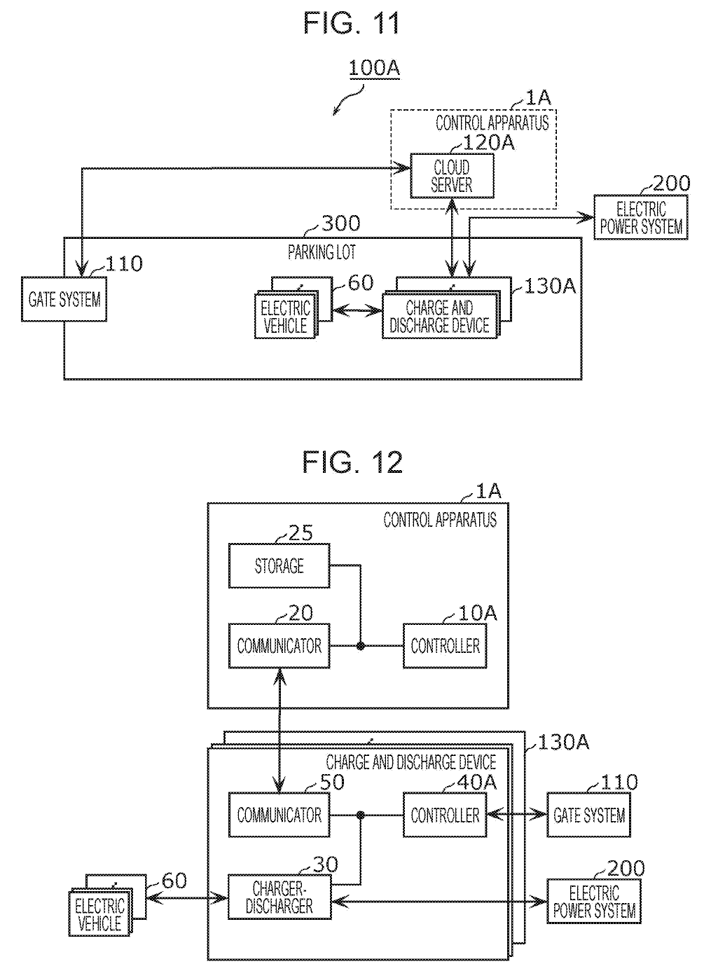

FIG. 11 is a block diagram showing an example of a hardware configuration of an electric power charge and discharge system 100A according to Embodiment 2.

As shown in FIG. 11, the electric power charge and discharge system 100A is configured to differ from the electric power charge and discharge system 100 according to Embodiment 1 in that the control apparatus 1 is replaced by a control apparatus 1A, that the charge and discharge devices 130 are replaced by charge and discharge devices 130A, and that the cloud server 120 is replaced by a cloud server 120A.

Although the cloud server 120A is similar in hardware configuration to the cloud server 120, the cloud server 120A executes software that is partly different from that which the cloud server 120 executes. For this reason, the cloud server 120A performs functions that are partly different from those which the cloud server 120 performs.

In addition to being similar in hardware configuration to the charge and discharge devices 130, the charge and discharge devices 130A each function also as a terminal including an inputted and a display (not illustrated). As one example, the charge and discharge devices 130A may each be provided with a touch panel including an input function and a display function.

The charge and discharge devices 130A execute software that is partly different from that which the charge and discharge devices 130 execute. For this reason, the charge and discharge devices 130A perform functions that are partly different from those which the charge and discharge devices 130 perform.

Embodiment 1 has been described on the assumption that a terminal 70 accepts an input operation from a user of an electric vehicle 60 and sends, to the control apparatus 1, information pertaining to the input operation thus accepted and that the terminal 70 receives information sent from the control apparatus 1 and performs a display pertaining to the information thus received. In Embodiment 2, on the other hand, a charge and discharge device 130A serves as a terminal to accept an input operation from a user of an electric vehicle 60 and sends, to the control apparatus 1A, information pertaining to the input operation thus accepted, and the charge and discharge device 130A receives information sent from the control apparatus 1A and a display of the charge and discharge device 130A performs a display pertaining to the information thus received.

The charge and discharge device 130A may further include, for example, a display, and when a connector of the charge and discharge device 130A is attached to a charging outlet of the electric vehicle 60, i.e. when the electric vehicle 60 is connected to the charger-discharger 30, the display displays information (e.g. a character string) that indicates an URL (uniform resource locator) for accessing a homepage for charger-discharger users prepared in the cloud server 120A. This enables a user who uses the charger-discharger 30 to use an inputter of the charge and discharge device 130A to access the homepage for charger-discharger users.

FIG. 12 is a block diagram showing an example of a functional configuration of the control apparatus 1A and the charge and discharge devices 130A.

In supplying electric power of at least one electric vehicle 60 parked in a facility to the electric power system 200 or at least one power receiving apparatus in the facility, the control apparatus 1A receives information that a user of the electric vehicle 60 inputted via an inputter of a charge and discharge device 130A and that indicates an SOC at which the user of the electric vehicle 60 wishes for the supply of the electric power of the electric vehicle 60 to be stopped, and the control apparatus 1A stops the supply of the electric power of the electric vehicle 60 when the SOC at which the user of the electric vehicle 60 wishes for the supply of the electric power of the electric vehicle 60 to be stopped is reached.

As shown in FIG. 12, the control apparatus 1A is configured to differ from the control apparatus 1 according to Embodiment 1 in that the controller 10 is replaced by a controller 10A, and the charge and discharge devices 130A are each configured to differ from the charge and discharge devices 130 according to Embodiment 1 in that the controller 40 is replaced by a controller 40A.

The controller 10A includes a processor and a memory having stored therein a control program that is executed by the processor.

The controller 10A sends, via the communicator 20 to the charge and discharge device 130A (communicator 50), information that indicates an SOC at which the user of the electric vehicle 60 wishes for the supply of the electric power of the electric vehicle 60 to be stopped.

The controller 40A includes a processor and a memory having stored therein a control program that is executed by the processor.

On the basis of the information received via the communicator 50, the controller 40A causes the supply of the electric power of the electric vehicle 60 to be executed until the SOC of a battery mounted in the electric vehicle 60 reaches the SOC at which the user of the electric vehicle 60 wishes for the supply of the electric power of the electric vehicle 60 to be stopped. In other words, the controller 40A causes the supply of the electric power of the electric vehicle 60 to be stopped when the SOC of the battery mounted in the electric vehicle 60 reaches the SOC at which the user of the electric vehicle 60 wishes for the supply of the electric power of the electric vehicle 60 to be stopped. This is an embodiment in which the controller 10A uses the controller 40A to indirectly cause the supply of the electric power of the electric vehicle 60 to be stopped when the SOC at which the user of the electric vehicle 60 wishes for the supply of the electric power of the electric vehicle 60 to be stopped is reached, and is encompassed in the "stopping the supply of the electric power of the electric vehicle when the SOC at which the user of the electric vehicle wishes for the supply of the electric power of the electric vehicle to be stopped is reached" of the present disclosure.

Further, the controller 10A sends to the charge and discharge device 130A, information that the controller 10A causes the display of the charge and discharge device 130A to display.

When the communicator 20 receives information, inputted by the user of the electric vehicle 60 via the inputter of the charge and discharge device 130A, that indicates a period of time during which the user of the electric vehicle 60 wishes for the supply of the electric power of the electric vehicle 60 to be executed, the controller 10A sends, to the charge and discharge device 130A (communicator 50), the information thus received that indicates the period of time during which the user of the electric vehicle 60 wishes for the supply of the electric power of the electric vehicle 60 to be executed.

On the basis of the information received via the communicator 50, the controller 40A may cause the supply of the electric power of the electric vehicle 60 to be executed over the period of time during which the user of the electric vehicle 60 wishes for the supply of the electric power of the electric vehicle 60 to be executed. In other words, the controller 40A may cause the supply of the electric power of the electric vehicle 60 to be stopped when the period of time during which the supply of the electric power of the electric vehicle 60 is executed reaches the period of time during which the user of the electric vehicle 60 wishes for the supply of the electric power of the electric vehicle 60 to be executed. This is an embodiment in which the controller 10A uses the controller 40A to indirectly cause the supply of the electric power of the electric vehicle 60 to be stopped when a point of time at which the user of the electric vehicle 60 wishes for the supply of the electric power of the electric vehicle 60 to be stopped is reached.

Further, the controller 10A determines supply power from the electric vehicle 60 so that the supply power from the electric vehicle 60 does not exceed an amount of electricity demanded by a different electric vehicle 60 serving as the power receiving apparatus in the facility, and sends, to the charge and discharge device 130A (communicator 50), information that indicates the supply power from the electric vehicle 60 thus determined.

On the basis of the information received via the communicator 50, the controller 40A controls the charger-discharger 30 to adjust the supply power from the electric vehicle 60. This is an embodiment in which the controller 10A uses the controller 40A to indirectly adjust the supply power from the electric vehicle 60 so that the supply power from the electric vehicle 60 does not exceed an amount of electricity demanded by a different electric vehicle 60 serving as the power receiving apparatus in the facility, and is encompassed in the clause "supply power from the electric vehicle is adjusted so as not to exceed an amount of electricity demanded by a different electric vehicle serving as the power receiving apparatus" of the present disclosure.

The controller 10A calculates, on the basis of received information that the communicator 20 received and that indicates the SOC at which the user of the electric vehicle 60 wishes for the supply of the electric power of the electric vehicle to be stopped, a period of time during which the supply of the electric power of the electric vehicle 60 is executed.

Upon determining that the SOC at which the user of the electric vehicle 60 wishes for the supply of the electric power of the electric vehicle 60 to be stopped is less than an SOC needed for the electric vehicle 60 to arrive at a destination from the facility, the controller 10A sends, via the communicator 20 to the charge and discharge device 130A (communicator 50), an error message or a message that suggests modifying the SOC at which the user of the electric vehicle 60 wishes for the supply of the electric power of the electric vehicle 60 to be stopped. At the charge and discharge device 130A, the controller 40A causes the display of the charge and discharge device 130A to display at least either of these messages. This is an embodiment in which the controller 10A uses the controller 40A to indirectly cause the display of the charge and discharge device 130A to display an error message or a message that suggests modifying the SOC at which the user of the electric vehicle 60 wishes for the supply of the electric power of the electric vehicle 60 to be stopped. Accordingly, this embodiment is encompassed in the clause "when the SOC at which the user of the electric vehicle wishes for the supply of the electric power of the electric vehicle to be stopped is less than an SOC needed for the electric vehicle to arrive at a destination from the facility, an error message or a message that suggests modifying the SOC at which the user of the electric vehicle wishes for the supply of the electric power of the electric vehicle to be stopped is displayed on a screen of the terminal" of the present disclosure.

Information that indicates the destination may be inputted to the inputter of the charge and discharge device 130A by the user of the electric vehicle 60, sent by the charge and discharge device 130A, received by the communicator 20, and stored in the storage 25. In this case, the information that indicates the destination may be associated with identification information of the user or identification information of the electric vehicle 60 and stored in the storage 25.

Further, upon determining that a capacity of an electric storage device serving as the power receiving apparatus in the facility is exceeded when the electric power of the electric vehicle 60 is supplied to the electric storage device until the SOC of the battery mounted in the electric vehicle 60 reaches the SOC at which the user of the electric vehicle 60 wishes for the supply of the electric power of the electric vehicle 60 to be stopped, the controller 10A sends, via the communicator 20 to the charge and discharge device 130A (communicator 50), an error message or a message that suggests modifying the SOC at which the user of the electric vehicle 60 wishes for the supply of the electric power of the electric vehicle 60 to be stopped. At the charge and discharge device 130A, the controller 40A may cause the display of the charge and discharge device 130A to display at least either of these messages. This is an embodiment in which the controller 10A uses the controller 40A to indirectly cause the display of the charge and discharge device 130A to display an error message or a message that suggests modifying the SOC at which the user of the electric vehicle 60 wishes for the supply of the electric power of the electric vehicle 60 to be stopped. Accordingly, this embodiment is encompassed in the clause "when a capacity of an electric storage device serving as the power receiving apparatus is exceeded when the electric power of the electric vehicle is supplied to the electric storage device until the SOC at which the user of the electric vehicle wishes for the supply of the electric power of the electric vehicle to be stopped is reached, an error message or a message that suggests modifying the SOC at which the user of the electric vehicle wishes for the supply of the electric power of the electric vehicle to be stopped is displayed on a screen of the terminal" of the present disclosure.

Further, upon determining that a power purchase demand of the electric power system 200 is exceeded when the electric power of the electric vehicle 60 is supplied to the electric power system 200 until the SOC of the battery mounted in the electric vehicle 60 reaches the SOC at which the user of the electric vehicle 60 wishes for the supply of the electric power of the electric vehicle 60 to be stopped, the controller 10A sends, via the communicator 20 to the charge and discharge device 130A (communicator 50), an error message or a message that suggests modifying the SOC at which the user of the electric vehicle 60 wishes for the supply of the electric power of the electric vehicle 60 to be stopped. At the charge and discharge device 130A, the controller 40A may cause the display of the charge and discharge device 130A to display at least either of these messages. Information that indicates the power purchase demand of the electric power system 200 may be received as appropriate from an aggregator via the communicator 20 and stored in the storage 25. This is an embodiment in which the controller 10A uses the controller 40A to indirectly cause the display of the charge and discharge device 130A to display an error message or a message that suggests modifying the SOC at which the user of the electric vehicle 60 wishes for the supply of the electric power of the electric vehicle 60 to be stopped. Accordingly, this embodiment is encompassed in the clause "when a power purchase demand of the electric power system is exceeded when the electric power of the electric vehicle is supplied to the electric power system until the SOC at which the user of the electric vehicle wishes for the supply of the electric power of the electric vehicle to be stopped is reached, an error message or a message that suggests modifying the SOC at which the user of the electric vehicle wishes for the supply of the electric power of the electric vehicle to be stopped is displayed on a screen of the terminal" of the present disclosure.

Further, the controller 10A may calculate, on the basis of information that indicates the SOC at which the user of the electric vehicle 60 wishes for the supply of the electric power of the electric vehicle 60 to be stopped, a period of time during which the supply of the electric power of the electric vehicle 60 is executed and send, via the communicator 20 to the charge and discharge device 130A (communicator 50), information that indicates the period of time. At the charge and discharge device 130A, the controller 40A may cause the display of the charge and discharge device 130A to display the information that indicates the period of time thus calculated. This is an embodiment in which the controller 10A uses the controller 40A to indirectly cause the display of the charge and discharge device 130A to display the information that indicates the period of time thus calculated. Accordingly, this embodiment is encompassed in the "calculating, on the basis of received information that indicates the SOC at which the user of the electric vehicle wishes for the supply of the electric power of the electric vehicle to be stopped, a period of time during which the supply of the electric power of the electric vehicle is executed and displaying, on a screen of the terminal, information that indicates the period of time thus calculated" of the present disclosure.

Further, the controller 10A may send, via the communicator 20 to the charge and discharge device 130A (communicator 50), information that checks with the user of the electric vehicle 60 whether the user of the electric vehicle 60 allows for a period of time during which the supply of the electric power of the electric vehicle 60 is executed. At the charge and discharge device 130A, the controller 40A may cause the display of the charge and discharge device 130A to display the information that checks with the aforementioned user. This is an embodiment in which the controller 10A uses the controller 40A to indirectly cause the display of the charge and discharge device 130A to display the information that checks with the aforementioned user. Accordingly, this embodiment is encompassed in the "causing the terminal to display information that checks with the user of the electric vehicle whether the user of the electric vehicle allows for a period of time during which the supply of the electric power of the electric vehicle is executed" of the present disclosure.

Further, when the communicator 20 receives information that indicates that the user of the electric vehicle 60 does not allow for a period of time during which the supply of the electric power of the electric vehicle 60 is executed, the controller 10A may send, via the communicator 20 to the charge and discharge device 130A (communicator 50), information that prompts inputting of information that indicates a period of time during which the user of the electric vehicle 60 wishes for the supply of the electric power of the electric vehicle 60 to be executed. At the charge and discharge device 130A, the controller 40A may cause the display of the charge and discharge device 130A to display the information that prompts the aforementioned inputting. This is an embodiment in which the controller 10A uses the controller 40A to indirectly cause the display of the charge and discharge device 130A to display the information that prompts the aforementioned inputting. Accordingly, this embodiment is encompassed in the "upon receiving the information that indicates that the user of the electric vehicle does not allow for a period of time during which the supply of the electric power of the electric vehicle is executed, causing the terminal to display information that prompts inputting of information that indicates a period of time during which the user of the electric vehicle wishes for the supply of the electric power of the electric vehicle to be executed" of the present disclosure.

Further, the controller 10A may send, to the charge and discharge device 130A (communicator 50), information that indicates a lower-limit value of an SOC that the user of the electric vehicle inputs via the inputter of the charge and discharge device 130A and at which the user of the electric vehicle 60 wishes for the supply of the electric power of the electric vehicle 60 to be stopped. At the charge and discharge device 130A, the controller 40A may cause the display of the charge and discharge device 130A to display the information that indicates the lower-limit value of the aforementioned SOC. In this case, the lower-limit value is set by the controller 10A to such a value as not to exceed a capacity of power reception of a different electric vehicle 60 serving as the power receiving apparatus in the facility. This is an embodiment in which the controller 10A uses the controller 40A to indirectly cause the display of the charge and discharge device 130A to display the information that indicates the lower-limit value of the aforementioned SOC. Accordingly, this embodiment is encompassed in the "causing the terminal to display a lower-limit value of an SOC that the user of the electric vehicle inputs via the terminal and at which the user of the electric vehicle wishes for the supply of the electric power of the electric vehicle to be stopped" of the present disclosure.

The capacity of power reception of the different electric vehicle 60 is the difference between the full-charge capacity of the different electric vehicle 60 and the present SOC of the different electric vehicle 60 and is calculated by the controller 10A. Information that indicates the full-charge capacity of the different electric vehicle 60 and information that indicates the present SOC of the different electric vehicle 60 are sent from the different electric vehicle 60 or a charge and discharge device 130A connected to the different electric vehicle 60, received via the communicator 20, and stored in the storage 25.

Further, when the SOC at which the user of the electric vehicle 60 wishes for the supply of the electric power of the electric vehicle 60 to be stopped is not less than the present SOC of the electric vehicle 60, the controller 10A may send, via the communicator 20 to the charge and discharge device 130A (communicator 50), an error message or a message that suggests modifying the SOC at which the user of the electric vehicle 60 wishes for the supply of the electric power of the electric vehicle 60 to be stopped. At the charge and discharge device 130A, the controller 40A may cause the display of the charge and discharge device 130A to display at least either of these messages. This is an embodiment in which the controller 10A uses the controller 40A to indirectly cause the display of the charge and discharge device 130A to display an error message or a message that suggests modifying the SOC at which the user of the electric vehicle 60 wishes for the supply of the electric power of the electric vehicle 60 to be stopped.

When the user of the electric vehicle 60 judges that the discharge of the electric vehicle 60 is not completed by the time of departure of the electric vehicle 60 with the SOC at which the user of the electric vehicle 60 wishes for the supply of the electric power of the electric vehicle 60 to be stopped, the controller 10A may send, via the communicator 20 to the charge and discharge device 130A (communicator 50), an error message or a message that suggests modifying the SOC at which the user of the electric vehicle 60 wishes for the supply of the electric power of the electric vehicle 60 to be stopped. At the charge and discharge device 130A, the controller 40A may cause the display of the charge and discharge device 130A to display at least either of these messages. This is an embodiment in which the controller 10A uses the controller 40A to indirectly cause the display of the charge and discharge device 130A to display an error message or a message that suggests modifying the SOC at which the user of the electric vehicle 60 wishes for the supply of the electric power of the electric vehicle 60 to be stopped.

### Operation

The following describes an operation that is performed by the electric power charge and discharge system 100A thus configured.

The electric power charge and discharge system 100A executes a second electric power discharge process that is partly different in process from the first electric power discharge process according to Embodiment 1.

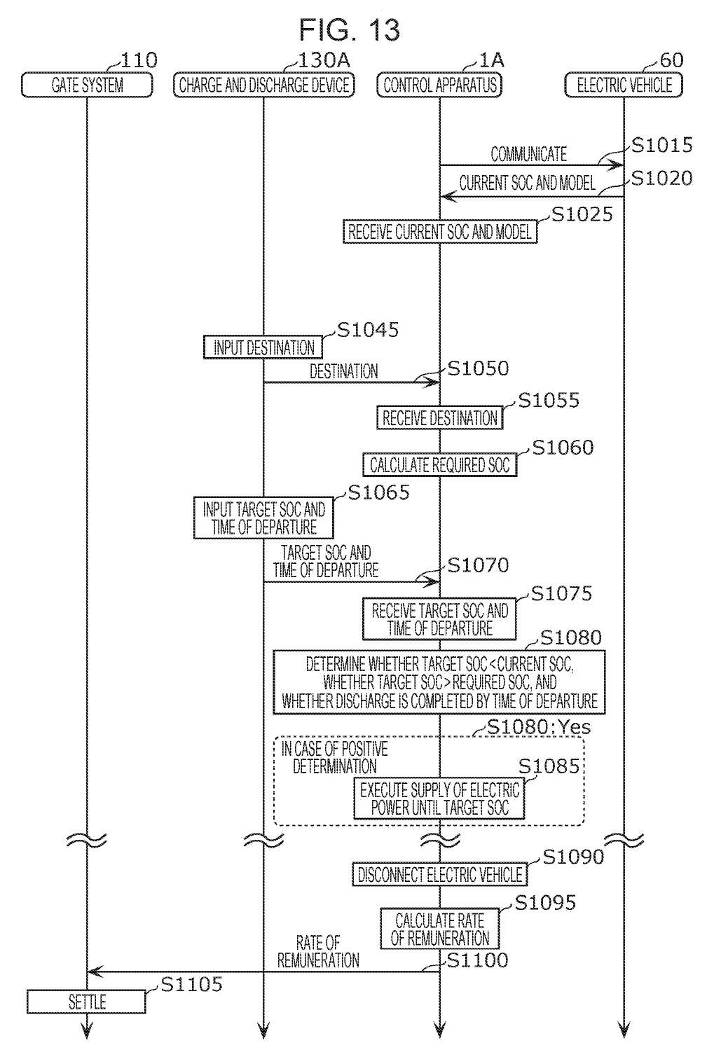

FIG. 13 is a sequence diagram of the second electric power discharge process that is performed by the electric power charge and discharge system 100A.

The processes of steps S1015 to S1025, the process of step S1060, and the processes of steps S1085 to S1105 are similar to the processes of steps S15 to S25, the process of step S60, and the processes of steps S85 to S105 of the first electric power discharge process in which the control apparatus 1 is read as "control apparatus 1A" and the controllers 10 and 40 are read as "controllers 10A and 40A", respectively. For this reason, the following description focuses on the processes of steps S1045 to S1080.

Upon completion of the process of step S1025, the user who uses the electric vehicle 60 operates the inputter of the charge and discharge device 130A to input a next destination of the electric vehicle 60 (step S1045). Then, the charge and discharge device 130A sends, to the control apparatus 1A, information that indicates the destination (step S1050), and the communicator 20 receives, from the charge and discharge device 130A, the information that indicates the destination (step S1055). Then, the process proceeds to the process of step S1060.

Upon completion of the process of step S1060, the user who uses the electric vehicle 60 operates the inputter of the charge and discharge device 130A to input a target SOC that is an SOC at which the user who uses the electric vehicle 60 wishes for the supply of the electric power of the electric vehicle 60 to be stopped and the time of departure of the electric vehicle 60 (step S1065). Then, the charge and discharge device 130A sends, to the control apparatus 1A, information that indicates the target SOC and information that indicates the time of departure (step S1070), and the communicator 20 receives, from the charge and discharge device 130A, the information that indicates the target SOC and the information that indicates the time of departure (step S1075).

When the communicator 20 receives the information that indicates the target SOC and the information that indicates the time of departure, the controller 10A determines (1) whether the target SOC is less than the current SOC, (2) whether the target SOC is greater than the required SOC, and (3) whether the discharge is completed by the time of departure (step S1080; this step being hereinafter also referred to as "discharge start condition determination"). Although all of (1) to (3) are used as conditions for determination, this is not intended to impose any limitation. At least one of (1) to (3) may be used as a condition for determination. In the foregoing sequence, the time of departure may be replaced by a length of time during which the user of the electric vehicle 60 can stay in the facility.

When a result of the discharge start condition determination is positive (step S1080; Yes), the controller 10A sends, to the charge and discharge device 130A, information that indicates that the result of the determination is positive, and this information is displayed on the display of the charge and discharge device 130A. After the user of the electric vehicle 60 has confirmed this information, a discharge instruction is given from the user of the electric vehicle 60. The discharge instruction is started, for example, by the user who uses the electric vehicle 60 performing an operation of instructing the charge and discharge device 130A to start the discharge of the electric vehicle 60. Then, the process proceeds to the process of step S1085. When the result of the discharge start condition determination is positive (step S1080; Yes), the controller 10A sends, to the charge and discharge device 130A, the information that indicates the target SOC. Accordingly, in step S1085, in accordance with the discharge instruction given by the user of the electric vehicle 60, the controller 40A of the charge and discharge device 130A controls the charger-discharger 30 to cause the charger-discharger 30 to execute the supply of the electric power of the electric vehicle 60 until the SOC of the battery mounted in the electric vehicle 60 reaches the SOC at which the user of the electric vehicle 60 wishes for the supply of the electric power of the electric vehicle 60 to be stopped. Although, in the foregoing, when the result of the discharge start condition determination is positive (step S1080; Yes), the controller 10A sends, to the charge and discharge device 130A, the information that indicates that the result of the determination is positive, the controller 10A may not send the information. In this case, the supply of the electric power of the electric vehicle 60 is started by the controller 10A sending, to the charge and discharge device 130A, not only the information that indicates the target SOC but also the discharge instruction. Alternatively, it is possible to execute step S1085 without executing step S1080. In this case, the supply of the electric power of the electric vehicle 60 is started by the controller 10A sending, to the charge and discharge device 130A, not only the information that indicates the target SOC but also the discharge instruction.

The controller 10A does not perform the process of step S1085 when the result of the discharge start condition determination is negative.

Upon completion of the process of step S1105, the second electric power discharge process ends.

In the aforementioned second electric power discharge process, after the end of the process of step S1075, at least one of the after-mentioned second message A display process, second message B display process, second message C display process, second message D display process, second message E display process, and second message FG display process may be performed in addition to or in place of the process of step S1080.

The electric power charge and discharge system 100A executes a second message A display process that is partly different in process from the first message A display process according to Embodiment 1.

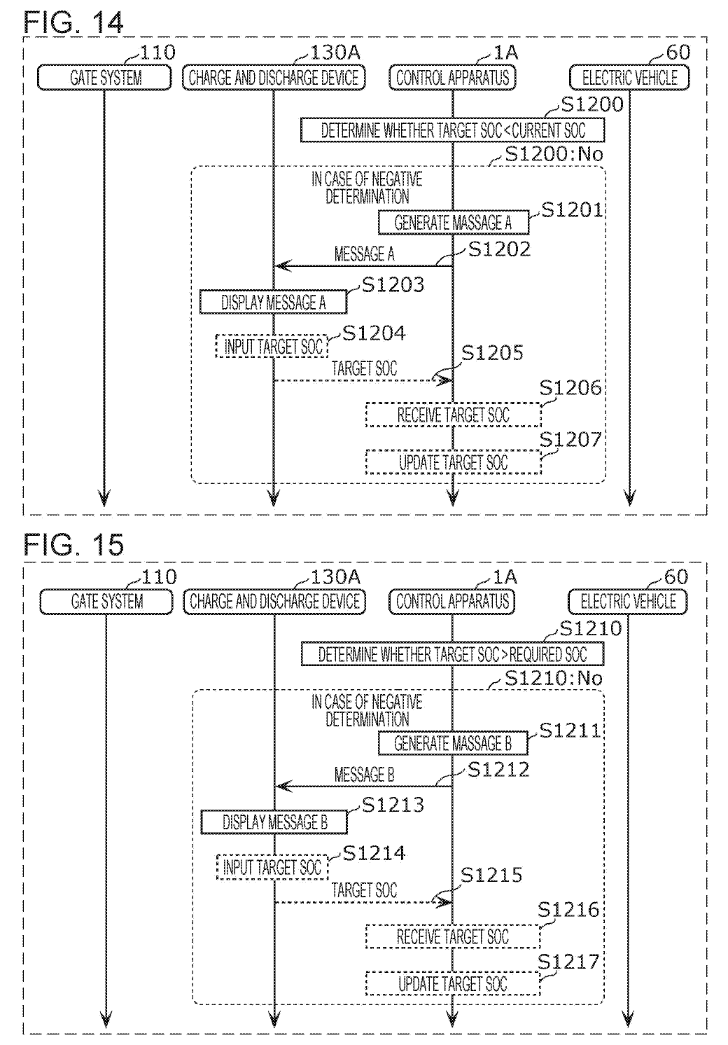

FIG. 14 is a sequence diagram of the second message A display process.

The processes of steps S1200 to S1201 and the process of step S1207 are similar to the processes of steps S200 to S201 and the process of step S207 of the first message A display process in which the control apparatus 1 is read as "control apparatus 1A" and the controllers 10 and 40 are read as "controllers 10A and 40A", respectively. For this reason, the following description focuses on the processes of steps S1202 to S1206.

Upon completion of the process of step S1201, the controller 10A sends, via the communicator 20 to the charge and discharge device 130A, the message A generated in the process of step S1201 (step S1202). At the charge and discharge device 130A, the controller 40A causes the display of the charge and discharge device 130A to display the message A (step S1203).

When the user who uses the electric vehicle 60 has confirmed the message A displayed on the display of the charge and discharge device 130A and operates the inputter of the charge and discharge device 130A to input a new target SOC (step S1204), the charge and discharge device 130A sends, to the control apparatus 1A, information that indicates the new target SOC inputted to the inputter of the charge and discharge device 130A (step S1205). Then, the communicator 20 receives, from the charge and discharge device 130A, the information that indicates the new SOC (step S1206), and the process proceeds to the process of step S1207.

When the determination made in the process of step S1200 is positive or upon completion of the process of step S1207, the second message A display process ends. When the second message A display process is executed after or in place of step S1080, a process that follows the time when the result of the determination made in step S1080 is positive is executed after the time when the determination made in the process of step S1200 is positive or after the process of step S1207.

The electric power charge and discharge system 100A executes a second message B display process that is partly different in process from the first message B display process according to Embodiment 1.

FIG. 15 is a sequence diagram of the second message B display process.

The processes of steps S1210 to S1211 and the process of step S1217 are similar to the processes of steps S210 to S211 and the process of step S217 of the first message B display process in which the control apparatus 1 is read as "control apparatus 1A" and the controllers 10 and 40 are read as "controllers 10A and 40A", respectively. For this reason, the following description focuses on the processes of steps S1212 to S1216.

Upon completion of the process of step S1211, the controller 10A sends, via the communicator 20 to the charge and discharge device 130A, the message B generated in the process of step S1211 (step S1212). At the charge and discharge device 130A, the controller 40A causes the display of the charge and discharge device 130A to display the message B (step S1213).

When the user who uses the electric vehicle 60 has confirmed the message B displayed on the display of the charge and discharge device 130A and operates the inputter of the charge and discharge device 130A to input a new target SOC (step S1214), the charge and discharge device 130A sends, to the control apparatus 1A, information that indicates the new target SOC inputted to the inputter of the charge and discharge device 130A (step S1215). Then, the communicator 20 receives from the charge and discharge device 130A, the information that indicates the new SOC (step S1216), and the process proceeds to the process of step S1217.

When the determination made in the process of step S1210 is positive or upon completion of the process of step S1217, the second message B display process ends. When the second message B display process is executed after or in place of step S1080, a process that follows the time when the result of the determination made in step S1080 is positive is executed after the time when the determination made in the process of step S1210 is positive or after the process of step S1217.

The electric power charge and discharge system 100A executes a second message C display process that is partly different in process from the first message C display process according to Embodiment 1.

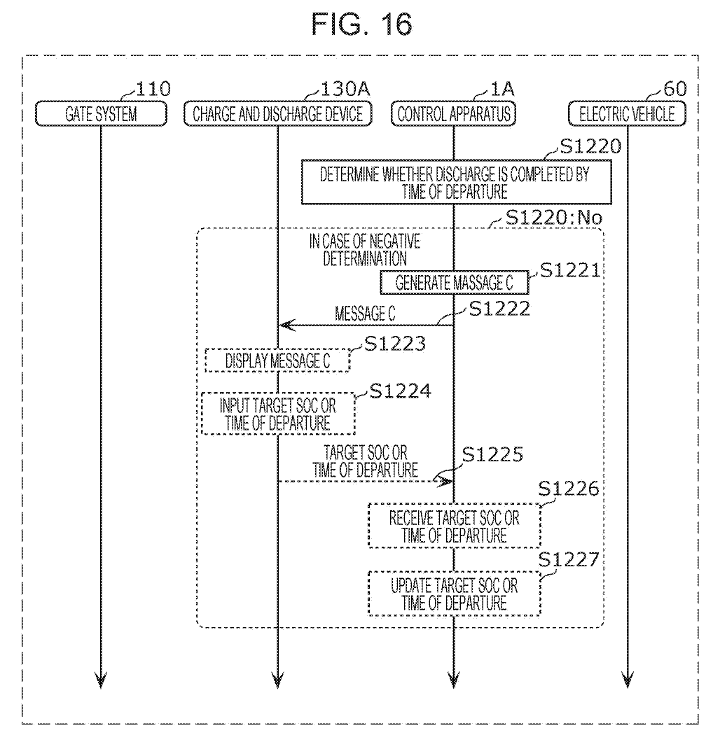

FIG. 16 is a sequence diagram of the second message C display process.

The processes of steps S1220 to S1221 and the process of step S1227 are similar to the processes of steps S220 to S221 and the process of step S227 of the first message C display process in which the control apparatus 1 is read as "control apparatus 1A" and the controllers 10 and 40 are read as "controllers 10A and 40A", respectively. For this reason, the following description focuses on the processes of steps S1222 to S1226.

Upon completion of the process of step S1221, the controller 10A sends, via the communicator 20 to the charge and discharge device 130A, the message C generated in the process of step S1221 (step S1222). At the charge and discharge device 130A, the controller 40A causes the display of the charge and discharge device 130A to display the message C (step S1223).

When the user who uses the electric vehicle 60 has confirmed the message C displayed on the display of the charge and discharge device 130A and operates the inputter of the charge and discharge device 130A to input a new target SOC or a new time of departure (step S1224), the charge and discharge device 130A sends, to the control apparatus 1A, information that indicates the new target SOC inputted to the inputter of the charge and discharge device 130A or information that indicates the new time of departure inputted to the inputter of the charge and discharge device 130A (step S1225). Then, the communicator 20 receives from the charge and discharge device 130A, the information that indicates the new SOC or the information that indicates the new time of departure (step S1226), and the process proceeds to the process of step S1227.

When the determination made in the process of step S1220 is positive or upon completion of the process of step S1227, the second message C display process ends. When the second message C display process is executed after or in place of step S1080, a process that follows the time when the result of the determination made in step S1080 is positive is executed after the time when the determination made in the process of step S1220 is positive or after the process of step S1227. In the present process, the time of departure may be replaced by the length of time during which the user of the electric vehicle 60 stays in the facility.

The electric power charge and discharge system 100A executes a second message D display process that is partly different in process from the first message D display process according to Embodiment 1.

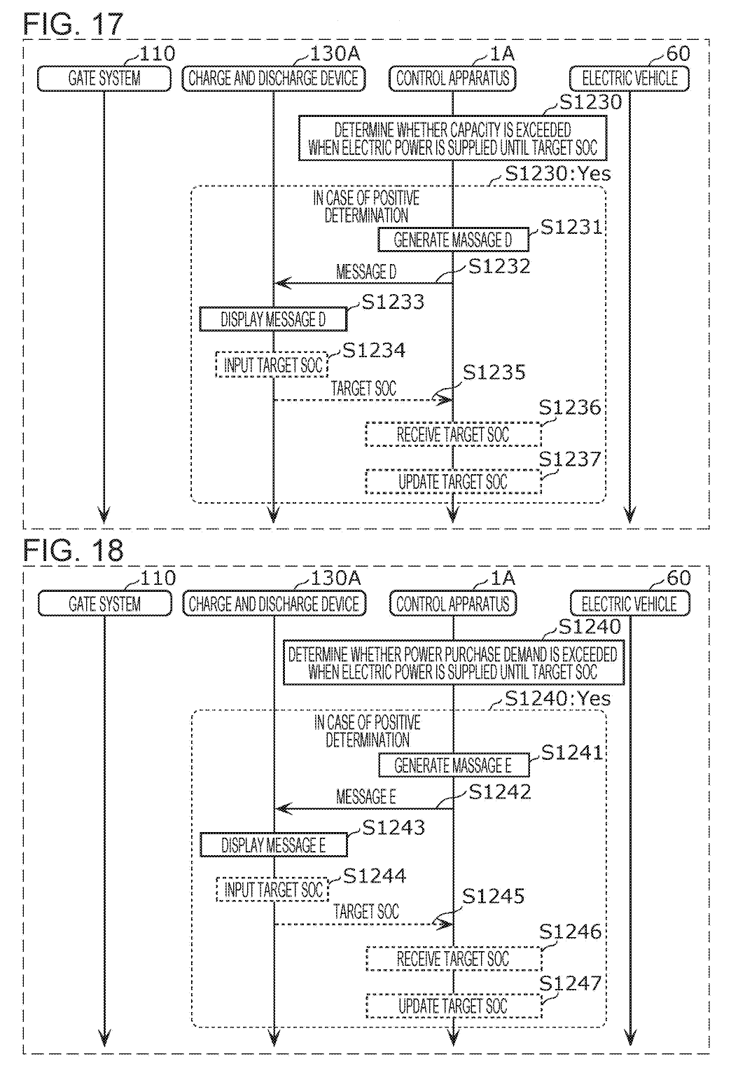

FIG. 17 is a sequence diagram of the second message D display process.

The processes of steps S1230 to S1231 and the process of step S1237 are similar to the processes of steps S230 to S231 and the process of step S237 of the first message D display process in which the control apparatus 1 is read as "control apparatus 1A" and the controllers 10 and 40 are read as "controllers 10A and 40A", respectively. For this reason, the following description focuses on the processes of steps S1232 to S1236.

Upon completion of the process of step S1231, the controller 10A sends, via the communicator 20 to the charge and discharge device 130A, the message D generated in the process of step S1231 (step S1232). At the charge and discharge device 130A, the controller 40A causes the display of the charge and discharge device 130A to display the message D (step S1233).

When the user who uses the electric vehicle 60 has confirmed the message D displayed on the display of the charge and discharge device 130A and operates the inputter of the charge and discharge device 130A to input a new target SOC (step S1234), the charge and discharge device 130A sends, to the control apparatus 1A, information that indicates the new target SOC inputted to the inputter of the charge and discharge device 130A (step S1235). Then, the communicator 20 receives, from the charge and discharge device 130A, the information that indicates the new SOC (step S1236), and the process proceeds to the process of step S1237.

When the determination made in the process of step S1230 is negative or upon completion of the process of step S1237, the second message D display process ends. When the second message D display process is executed after or in place of step S1080, a process that follows the time when the result of the determination made in step S1080 is positive is executed after the time when the determination made in the process of step S1230 is positive or after the process of step S1237.

The electric power charge and discharge system 100A executes a second message E display process that is partly different in process from the first message E display process according to Embodiment 1.

FIG. 18 is a sequence diagram of the second message E display process.

The processes of steps S1240 to S1241 and the process of step S1247 are similar to the processes of steps S240 to S241 and the process of step S247 of the first message E display process in which the control apparatus 1 is read as "control apparatus 1A" and the controllers 10 and 40 are read as "controllers 10A and 40A", respectively. For this reason, the following description focuses on the processes of steps S1242 to S1246.

Upon completion of the process of step S1241, the controller 10A sends, via the communicator 20 to the charge and discharge device 130A, the message E generated in the process of step S1241 (step S1242). At the charge and discharge device 130A, the controller 40A causes the display of the charge and discharge device 130A to display the message E (step S1243).

When the user who uses the electric vehicle 60 has confirmed the message E displayed on the display of the charge and discharge device 130A and operates the inputter of the charge and discharge device 130A to input a new target SOC (step S1244), the charge and discharge device 130A sends, to the control apparatus 1A, information that indicates the new target SOC inputted to the inputter of the charge and discharge device 130A (step S1245). Then, the communicator 20 receives, from the charge and discharge device 130A, the information that indicates the new SOC (step S1246), and the process proceeds to the process of step S1247.

When the determination made in the process of step S1240 is negative or upon completion of the process of step S1247, the second message E display process ends. When the second message E display process is executed after or in place of step S1080, a process that follows the time when the result of the determination made in step S1080 is positive is executed after the time when the determination made in the process of step S1240 is positive or after the process of step S1247.

The electric power charge and discharge system 100A executes a second message FG display process that is partly different in process from the first message FG display process according to Embodiment 1.

FIG. 19 is a sequence diagram of the second message FG display process.

The process of step S1250, the process of step S1253, and the process of step S1259 are similar to the process of step S250, the process of step S253, and the process of step S259 of the first message FG display process in which the control apparatus 1 is read as "control apparatus 1A" and the controllers 10 and 40 are read as "controllers 10A and 40A", respectively. For this reason, the following description focuses on the processes of steps S1251 to S1252, the processes of steps S1254 to S1258, and the processes of steps S1260 to S1264.

Upon completion of the process of step S1250, the controller 10A sends, via the communicator 20 to the charge and discharge device 130A, information that indicates the period of charge execution calculated in step S1250 (step S1251). At the charge and discharge device 130A, the controller 40A causes the display of the charge and discharge device 130A to display the information that indicates the period of charge execution (step S1252), and the process proceeds to the process of step S1253.

The controller 10A sends, via the communicator 20 to the charge and discharge device 130A, the message F generated in the process of step S1253 (step S1254). At the charge and discharge device 130A, the controller 40A causes the display of the charge and discharge device 130A to display the message F (step S1255).

When the user who uses the electric vehicle 60 has confirmed the message F displayed on the display of the charge and discharge device 130A and operates the inputter of the charge and discharge device 130A to perform input to the effect that the user who uses the electric vehicle 60 does not allow for the period of charge execution (step S1256), the charge and discharge device 130A sends, to the control apparatus 1A, information that indicates that the user who uses the electric vehicle 60 does not allow for the period of charge execution (step S1257). Then, the communicator 20 receives from the charge and discharge device 130A, the information that indicates that the user who uses the electric vehicle 60 does not allow for the period of charge execution (step S1258), and the process proceeds to the process of step S1259.

The controller 10A sends, via the communicator 20 to the charge and discharge device 130A, the massage G generated in the process of step S1259 (step S1260). At the charge and discharge device 130A, the controller 40A causes the display of the charge and discharge device 130A to display the message G (step S1261).

When the user who uses the electric vehicle 60 has confirmed the message G displayed on the display of the charge and discharge device 130A and operates the inputter of the charge and discharge device 130A to input the desired period of supply (step S1262), the charge and discharge device 130A sends, to the control apparatus 1A, information that indicates the desired period of supply inputted to the inputter of the charge and discharge device 130A (step S1263). Then, the communicator 20 receives from the charge and discharge device 130A, the information that indicates the desired period of supply (step S1264).

When the user of the electric vehicle 60 has performed input in the process of step S1256 to the effect that the user of the electric vehicle 60 allows for the period of charge execution or upon completion of the process of step S1264, the second message FG display process ends.

When the user of the electric vehicle 60 has performed input in the process of step S1256 to the effect that the user of the electric vehicle 60 allows for the period of charge execution or when the process of step S1085 of the second electric power discharge process is executed when the process of step S1264 has been executed, the controller 10A causes the supply of the electric power of the electric vehicle 60 to be executed over the desired period of supply in the process of step S1085. In other words, the supply of the electric power of the electric vehicle 60 is stopped when the desired period of supply elapses.

Furthermore, prior to the start of the process of step S1065 in the second electric power discharge process, the after-mentioned second message H display process may be performed in addition to or in place of the process of step S1060.

The electric power charge and discharge system 100A executes a second message H display process that is partly different in process from the first message H display process according to Embodiment 1.

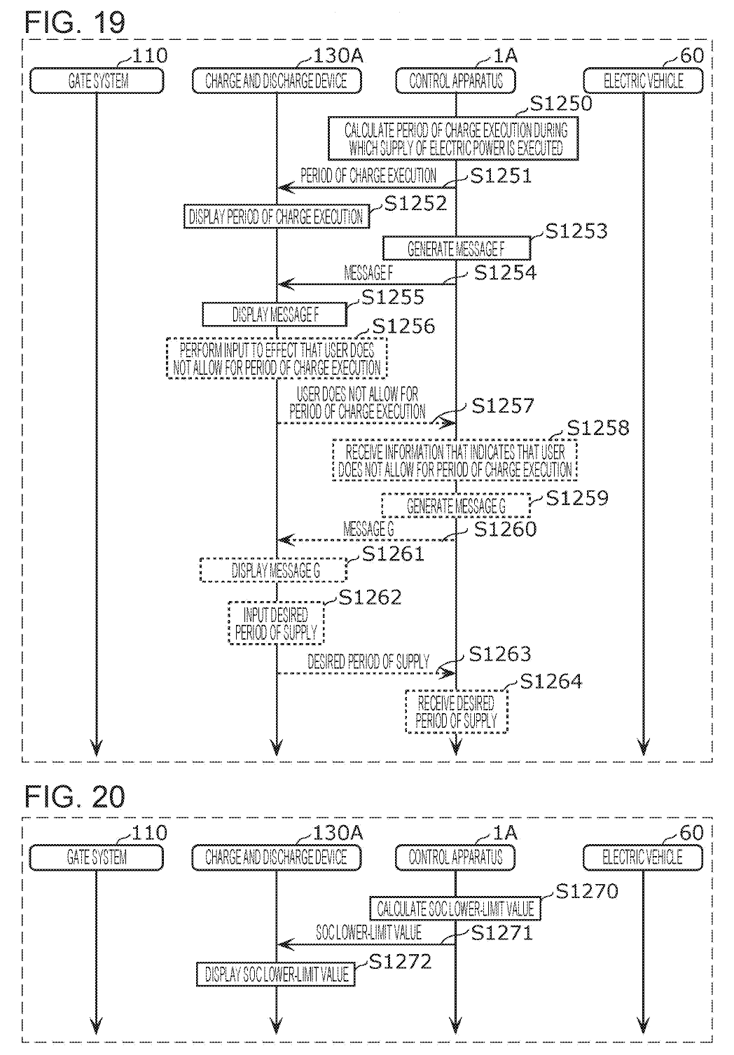

FIG. 20 is a sequence diagram of the second message H display process.

The process of step S1270 is similar to the process of step S270 of the first message H display process in which the control apparatus 1 is read as "control apparatus 1A" and the controllers 10 and 40 are read as "controllers 10A and 40A", respectively. For this reason, the following description focuses on the processes of steps S1271 to S1272.

Upon completion of the process of step S1270, the controller 10A sends to the charge and discharge device 130A, information that indicates the SOC lower-limit value calculated in step S1270 (step S1271). At the charge and discharge device 130A, the controller 40A causes the display of the charge and discharge device 130A to display the information that indicates the SOC lower-limit value thus calculated (step S1272). This allows the user of the electric vehicle 60 to input the target SOC in the process of step S1065 of the second electric power discharge process with reference to the SOC lower-limit value displayed on the display of the charge and discharge device 130A.

Upon completion of the process of step S1272, the second message H display process ends.

### Embodiment 3

The following describes an electric power charge and discharge system according to Embodiment 3 that is partly different in configuration from the electric power charge and discharge system 100A according to Embodiment 2.

The electric power charge and discharge system 100A according to Embodiment 2 is an example of being configured to include a cloud server 120A. On the other hand, the electric power charge and discharge system according to Embodiment 3 is an example of being configured not to include a cloud server.

Constituent elements of the electric power charge and discharge system according to Embodiment 3 that are similar to those of the electric power charge and discharge system 100A are given the same reference signs as having been already described. A detailed description of such constituent elements is omitted. The electric power charge and discharge system according to Embodiment 3 is described with a focus on points of difference from the electric power charge and discharge system 100A.

### Configuration

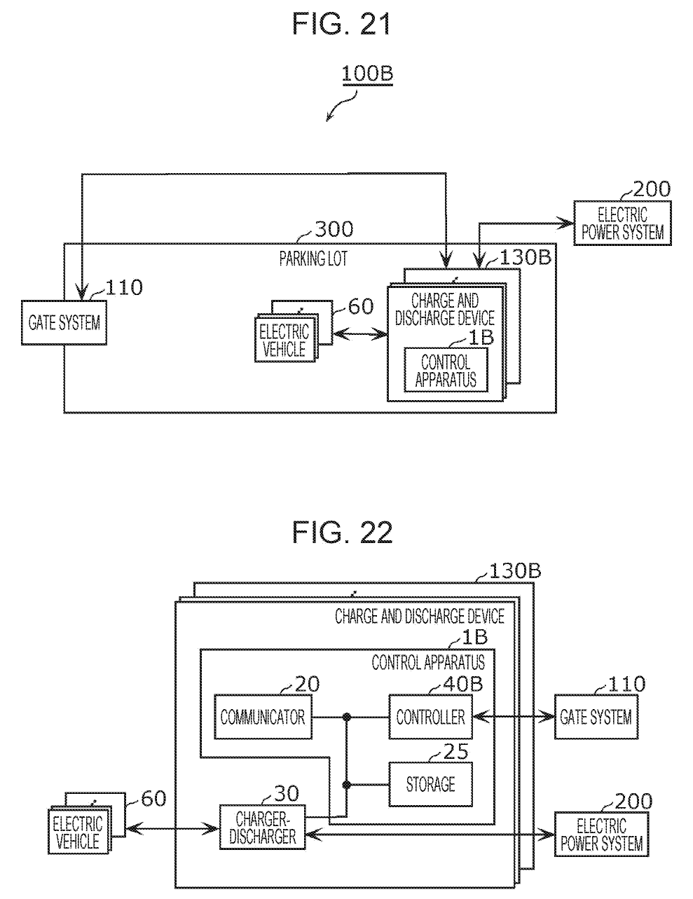

FIG. 21 is a block diagram showing an example of a hardware configuration of an electric power charge and discharge system 100B according to Embodiment 3.

As shown in FIG. 21, the electric power charge and discharge system 100B is configured to differ from the electric power charge and discharge system 100A according to Embodiment 2 in that the control apparatus 1A is replaced by a control apparatus 1B, that the charge and discharge devices 130A are replaced by charge and discharge devices 130B, and that the cloud server 120A is removed.

Although the charge and discharge devices 130B are similar in hardware configuration to the charge and discharge devices 130A, the charge and discharge devices 130B execute software that is partly different from that which the charge and discharge devices 130A execute. For this reason, the charge and discharge devices 130B perform functions that are partly different from those which the charge and discharge devices 130A perform.

FIG. 22 is a block diagram showing an example of a functional configuration of the control apparatus 1B.

In supplying electric power of at least one electric vehicle 60 parked in a facility to the electric power system 200 or at least one power receiving apparatus in the facility, the control apparatus 1B stops the supply of the electric power of the electric vehicle 60 when an SOC that a user of the electric vehicle 60 inputted via an inputter of a charge and discharge device 130B and at which the user of the electric vehicle 60 wishes for the supply of the electric power of the electric vehicle 60 to be stopped is reached.

As shown in FIG. 22, the control apparatus 1B is configured to differ from the control apparatus 1A and the charge and discharge device 130A according to Embodiment 2 in that the controller 40A is replaced by a controller 40B and that the controller 10A and the communicator 50 are removed.

The controller 40B includes a processor and a memory having stored therein a control program that is executed by the processor.

On the basis of the information that indicates the SOC at which the user of the electric vehicle 60 wishes for the supply of the electric power of the electric vehicle 60 to be stopped, the controller 40B causes the supply of the electric power of the electric vehicle 60 to be executed until the SOC of a battery mounted in the electric vehicle 60 reaches the SOC at which the user of the electric vehicle 60 wishes for the supply of the electric power of the electric vehicle 60 to be stopped. In other words, the controller 40B causes the supply of the electric power of the electric vehicle 60 to be stopped when the SOC of the battery mounted in the electric vehicle 60 reaches the SOC at which the user of the electric vehicle 60 wishes for the supply of the electric power of the electric vehicle 60 to be stopped. This is an embodiment in which the controller 40B directly causes the supply of the electric power of the electric vehicle 60 to be stopped when the SOC at which the user of the electric vehicle 60 wishes for the supply of the electric power of the electric vehicle 60 to be stopped is reached, and is encompassed in the "stopping the supply of the electric power of the electric vehicle when the SOC at which the user of the electric vehicle wishes for the supply of the electric power of the electric vehicle to be stopped is reached" of the present disclosure.

Further, on the basis of the information, inputted by the user of the electric vehicle 60 via the inputter of the charge and discharge device 130B, that indicates a period of time during which the user of the electric vehicle 60 wishes for the supply of the electric power of the electric vehicle 60 to be executed, the controller 40B may cause the supply of the electric power of the electric vehicle 60 to be executed over the period of time during which the user of the electric vehicle 60 wishes for the supply of the electric power of the electric vehicle 60 to be executed. In other words, the controller 40B may cause the supply of the electric power of the electric vehicle 60 to be stopped when the period of time during which the supply of the electric power of the electric vehicle 60 is executed reaches the period of time during which the user of the electric vehicle 60 wishes for the supply of the electric power of the electric vehicle 60 to be executed. This is an embodiment in which the controller 40B directly causes the supply of the electric power of the electric vehicle 60 to be stopped when a point of time at which the user of the electric vehicle 60 wishes for the supply of the electric power of the electric vehicle 60 to be stopped is reached.

Further, the controller 40B determines supply power from the electric vehicle 60 so that the supply power from the electric vehicle 60 does not exceed an amount of electricity demanded by a different electric vehicle 60 serving as the power receiving apparatus in the facility, and on the basis of information that indicates the supply power from the electric vehicle 60 thus determined, the controller 40B controls the charger-discharger 30 to adjust the supply power from the electric vehicle 60. This is an embodiment in which the controller 40B directly adjusts the supply power from the electric vehicle 60 so that the supply power from the electric vehicle 60 does not exceed an amount of electricity demanded by a different electric vehicle 60 serving as the power receiving apparatus in the facility, and is encompassed in the clause "supply power from the electric vehicle is adjusted so as not to exceed an amount of electricity demanded by a different electric vehicle serving as the power receiving apparatus" of the present disclosure.

The controller 40B calculates, on the basis of information that indicates the SOC at which the user of the electric vehicle 60 wishes for the supply of the electric power of the electric vehicle to be stopped, a period of time during which the supply of the electric power of the electric vehicle 60 is executed.

Upon determining that the SOC at which the user of the electric vehicle 60 wishes for the supply of the electric power of the electric vehicle 60 to be stopped is less than an SOC needed for the electric vehicle 60 to arrive at a destination from the facility, the controller 40B causes the display of the charge and discharge device 130B to display at least either an error message or a message that suggests modifying the SOC at which the user of the electric vehicle 60 wishes for the supply of the electric power of the electric vehicle 60 to be stopped. This is an embodiment in which the controller 40B directly causes the display of the charge and discharge device 130B to display an error message or a message that suggests modifying the SOC at which the user of the electric vehicle 60 wishes for the supply of the electric power of the electric vehicle 60 to be stopped. Accordingly, this embodiment is encompassed in the clause "when the SOC at which the user of the electric vehicle wishes for the supply of the electric power of the electric vehicle to be stopped is less than an SOC needed for the electric vehicle to arrive at a destination from the facility, an error message or a message that suggests modifying the SOC at which the user of the electric vehicle wishes for the supply of the electric power of the electric vehicle to be stopped is displayed on a screen of the terminal" of the present disclosure.

Information that indicates the destination may be inputted to the inputter of the charge and discharge device 130B by the user of the electric vehicle 60 and stored in the storage 25. In this case, the information that indicates the destination may be associated with identification information of the user or identification information of the electric vehicle 60 and stored in the storage 25.

Further, upon determining that a capacity of an electric storage device serving as the power receiving apparatus in the facility is exceeded when the electric power of the electric vehicle 60 is supplied to the electric storage device until the SOC of the battery mounted in the electric vehicle 60 reaches the SOC at which the user of the electric vehicle 60 wishes for the supply of the electric power of the electric vehicle 60 to be stopped, the controller 40B may cause the display of the charge and discharge device 130B to display at least either an error message or a message that suggests modifying the SOC at which the user of the electric vehicle 60 wishes for the supply of the electric power of the electric vehicle 60 to be stopped. This is an embodiment in which the controller 40B directly causes the display of the charge and discharge device 130B to display an error message or a message that suggests modifying the SOC at which the user of the electric vehicle 60 wishes for the supply of the electric power of the electric vehicle 60 to be stopped. Accordingly, this embodiment is encompassed in the clause "when a capacity of an electric storage device serving as the power receiving apparatus is exceeded when the electric power of the electric vehicle is supplied to the electric storage device until the SOC at which the user of the electric vehicle wishes for the supply of the electric power of the electric vehicle to be stopped is reached, an error message or a message that suggests modifying the SOC at which the user of the electric vehicle wishes for the supply of the electric power of the electric vehicle to be stopped is displayed on a screen of the terminal" of the present disclosure.

Further, upon determining that a power purchase demand of the electric power system 200 is exceeded when the electric power of the electric vehicle 60 is supplied to the electric power system 200 until the SOC of the battery mounted in the electric vehicle 60 reaches the SOC at which the user of the electric vehicle 60 wishes for the supply of the electric power of the electric vehicle 60 to be stopped, the controller 40B may cause the display of the charge and discharge device 130B to display at least either an error message or a message that suggests modifying the SOC at which the user of the electric vehicle 60 wishes for the supply of the electric power of the electric vehicle 60 to be stopped. Information that indicates the power purchase demand of the electric power system 200 may be received as appropriate from an aggregator and stored in the storage 25. This is an embodiment in which the controller 40B directly causes the display of the charge and discharge device 130B to display an error message or a message that suggests modifying the SOC at which the user of the electric vehicle 60 wishes for the supply of the electric power of the electric vehicle 60 to be stopped. Accordingly, this embodiment is encompassed in the clause "when a power purchase demand of the electric power system is exceeded when the electric power of the electric vehicle is supplied to the electric power system until the SOC at which the user of the electric vehicle wishes for the supply of the electric power of the electric vehicle to be stopped is reached, an error message or a message that suggests modifying the SOC at which the user of the electric vehicle wishes for the supply of the electric power of the electric vehicle to be stopped is displayed on a screen of the terminal" of the present disclosure.

Further, the controller 40B may calculate, on the basis of information that indicates the SOC at which the user of the electric vehicle 60 wishes for the supply of the electric power of the electric vehicle 60 to be stopped, a period of time during which the supply of the electric power of the electric vehicle 60 is executed and cause the display of the charge and discharge device 130B to display information that indicates the period of time thus calculated. This is an embodiment in which the controller 40B directly causes the display of the charge and discharge device 130B to display the information that indicates the period of time thus calculated. Accordingly, this embodiment is encompassed in the "calculating, on the basis of received information that indicates the SOC at which the user of the electric vehicle wishes for the supply of the electric power of the electric vehicle to be stopped, a period of time during which the supply of the electric power of the electric vehicle is executed and displaying, on a screen of the terminal, information that indicates the period of time thus calculated" of the present disclosure.

Further, the controller 40B may cause the display of the charge and discharge device 130B to display information that checks with the user of the electric vehicle 60 whether the user of the electric vehicle 60 allows for a period of time during which the supply of the electric power of the electric vehicle 60 is executed. This is an embodiment in which the controller 40B directly causes the display of the charge and discharge device 130B to display the information that checks with the aforementioned user. Accordingly, this embodiment is encompassed in the "causing the terminal to display information that checks with the user of the electric vehicle whether the user of the electric vehicle allows for a period of time during which the supply of the electric power of the electric vehicle is executed" of the present disclosure.

Further, when the inputter of the charge and discharge device 130B accepts input that indicates that the user of the electric vehicle 60 does not allow for a period of time during which the supply of the electric power of the electric vehicle 60 is executed, the controller 40B may cause the display the charge and discharge device 130B to display information that prompts inputting of information that indicates a period of time during which the user of the electric vehicle 60 wishes for the supply of the electric power of the electric vehicle 60 to be executed. This is an embodiment in which the controller 40B directly causes the display of the charge and discharge device 130B to display the information that prompts the aforementioned inputting. Accordingly, this embodiment is encompassed in the "upon receiving the information that indicates that the user of the electric vehicle does not allow for a period of time during which the supply of the electric power of the electric vehicle is executed, causing the terminal to display information that prompts inputting of information that indicates a period of time during which the user of the electric vehicle wishes for the supply of the electric power of the electric vehicle to be executed" of the present disclosure.

Further, the controller 40B may cause the display of the charge and discharge device 130B to display information that indicates a lower-limit value of an SOC that the user of the electric vehicle inputs via the inputter of the charge and discharge device 130B and at which the user of the electric vehicle 60 wishes for the supply of the electric power of the electric vehicle 60 to be stopped. In this case, the lower-limit value is set by the controller 40B to such a value as not to exceed a capacity of power reception of a different electric vehicle 60 serving as the power receiving apparatus in the facility. This is an embodiment in which the controller 40B directly causes the display of the charge and discharge device 130B to display the information that indicates the lower-limit value of the aforementioned SOC. Accordingly, this embodiment is encompassed in the "causing the terminal to display a lower-limit value of an SOC that the user of the electric vehicle inputs via the terminal and at which the user of the electric vehicle wishes for the supply of the electric power of the electric vehicle to be stopped" of the present disclosure. The capacity of power reception of the different electric vehicle 60 is the difference between the full-charge capacity of the different electric vehicle 60 and the present SOC of the different electric vehicle 60 and is calculated by the controller 40B. Information that indicates the full-charge capacity of the different electric vehicle 60 and information that indicates the present SOC of the different electric vehicle 60 are sent from the different electric vehicle 60, received via the communicator 20, and stored in the storage 25.

Further, when the SOC at which the user of the electric vehicle 60 wishes for the supply of the electric power of the electric vehicle 60 to be stopped is not less than the present SOC of the electric vehicle 60, the controller 40B may cause the display of the charge and discharge device 130B to display at least either an error message or a message that suggests modifying the SOC at which the user of the electric vehicle 60 wishes for the supply of the electric power of the electric vehicle 60 to be stopped. This is an embodiment in which the controller 40B directly causes the display of the charge and discharge device 130B to display an error message or a message that suggests modifying the SOC at which the user of the electric vehicle 60 wishes for the supply of the electric power of the electric vehicle 60 to be stopped.

When the user of the electric vehicle 60 judges that the discharge of the electric vehicle 60 is not completed by the time of departure of the electric vehicle 60 with the SOC at which the user of the electric vehicle 60 wishes for the supply of the electric power of the electric vehicle 60 to be stopped, the controller 40B may cause the display of the charge and discharge device 130B to display at least either an error message or a message that suggests modifying the SOC at which the user of the electric vehicle 60 wishes for the supply of the electric power of the electric vehicle 60 to be stopped. This is an embodiment in which the controller 40B directly causes the display of the charge and discharge device 130B to display an error message or a message that suggests modifying the SOC at which the user of the electric vehicle 60 wishes for the supply of the electric power of the electric vehicle 60 to be stopped.

### Operation

The following describes an operation that is performed by the electric power charge and discharge system 100B thus configured.

The electric power charge and discharge system 100B executes a third electric power discharge process that is partly different in process from the second electric power discharge process according to Embodiment 2.

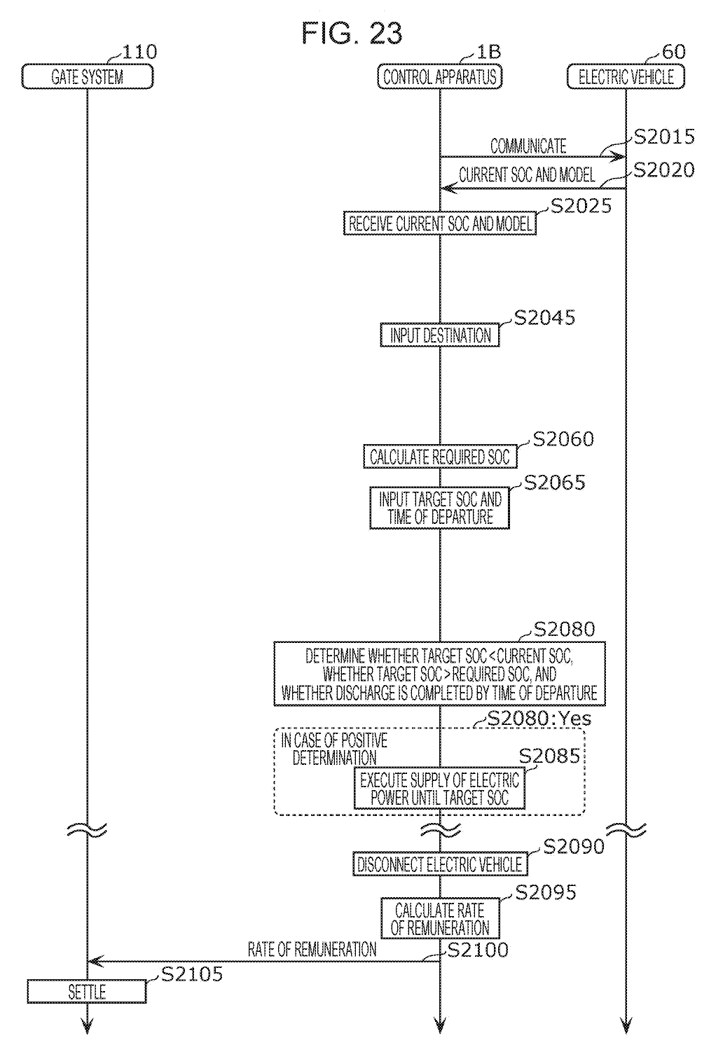

FIG. 23 is a sequence diagram of the third electric power discharge process that is performed by the electric power charge and discharge system 100B.

The processes of steps S2015 to S2025, the process of step S2060, and the processes of steps S2085 to S2105 are similar to the processes of steps S1015 to S1025, the process of step S1060, and the processes of steps S1085 to S1105 of the second electric power discharge process in which the control apparatus 1A is read as "control apparatus 1B" and the controllers 10A and 40A are read as "controller 40B", respectively. For this reason, the following description focuses on the processes of steps S2045 to S2080.

Upon completion of the process of step S2025, the user who uses the electric vehicle 60 operates the inputter of the charge and discharge device 130B to input a next destination of the electric vehicle 60 (step S2045). Then, the process proceeds to the process of step S2060.

Upon completion of the process of step S2060, the user who uses the electric vehicle 60 operates the inputter of the charge and discharge device 130B to input a target SOC that is an SOC at which the user who uses the electric vehicle 60 wishes for the supply of the electric power of the electric vehicle 60 to be stopped and the time of departure of the electric vehicle 60 (step S2065). Then, the controller 40B determines (1) whether the target SOC is less than the current SOC, (2) whether the target SOC is greater than the required SOC, and (3) whether the discharge is completed by the time of departure (step S2080; this step being hereinafter also referred to as "discharge start condition determination"). Although all of (1) to (3) are used as conditions for determination, this is not intended to impose any limitation. At least one of (1) to (3) may be used as a condition for determination. In the foregoing sequence, the time of departure may be replaced by a length of time during which the user of the electric vehicle 60 can stay in the facility.

When a result of the discharge start condition determination is positive (step S2080; Yes), the controller 40B causes the display of the charge and discharge device 130B to display information that indicates that the result of the determination is positive. After the user of the electric vehicle 60 has confirmed this information, a discharge instruction is given from the user of the electric vehicle 60. The discharge instruction is started, for example, by the user who uses the electric vehicle 60 performing an operation of instructing the charge and discharge device 130B to start the discharge of the electric vehicle 60. Then, the process proceeds to the process of step S2085. Although, in the foregoing, when the result of the discharge start condition determination is positive (step S2080; Yes), the controller 40B causes the display of the charge and discharge device 130B to display the information that indicates that the result of the determination is positive, the controller 40B may not cause the display of the charge and discharge device 130B to display the information. In this case, the controller 40B may start the supply of the electric power of the electric vehicle 60 with or without a discharge instruction given through an input operation performed by the user of the electric vehicle. Alternatively, it is possible to execute step S2085 without executing step S2080. In this case, the controller 40B starts the supply of the electric power of the electric vehicle 60 after the process of step S2065.

The controller 40B does not perform the process of step S2085 when the result of the discharge start condition determination is negative.

Upon completion of the process of step S2105, the third electric power discharge process ends.

In the aforementioned third electric power discharge process, after the end of the process of step S2075, at least one of the after-mentioned third message A display process, third message B display process, third message C display process, third message D display process, third message E display process, and third message FG display process may be performed in addition to or in place of the process of step S2080.

The electric power charge and discharge system 100B executes a third message A display process that is partly different in process from the second message A display process according to Embodiment 2.

FIG. 24 is a sequence diagram of the third message A display process.

The processes of steps S2200 to S2201 and the process of step S2207 are similar to the processes of steps S1200 to S1201 and the process of step S1207 of the second message A display process in which the control apparatus 1A is read as "control apparatus 1B" and the controllers 10A and 40A are read as "controller 40B", respectively. For this reason, the following description focuses on the processes of steps S2202 to S2206.

Upon completion of the process of step S2201, the controller 40B causes the display of the charge and discharge device 130B to display the message A (step S2203).

When the user who uses the electric vehicle 60 has confirmed the message A displayed on the display of the charge and discharge device 130B and operates the inputter of the charge and discharge device 130B to input a new target SOC (step S2204), the process proceeds to the process of step S2207.

When the determination made in the process of step S2200 is positive or upon completion of the process of step S2207, the third message A display process ends. When the third message A display process is executed after or in place of step S2080, a process that follows the time when the result of the determination made in step S2080 is positive is executed after the time when the determination made in the process of step S2200 is positive or after the process of step S2207.

The electric power charge and discharge system 100B executes a third message B display process that is partly different in process from the second message B display process according to Embodiment 2.

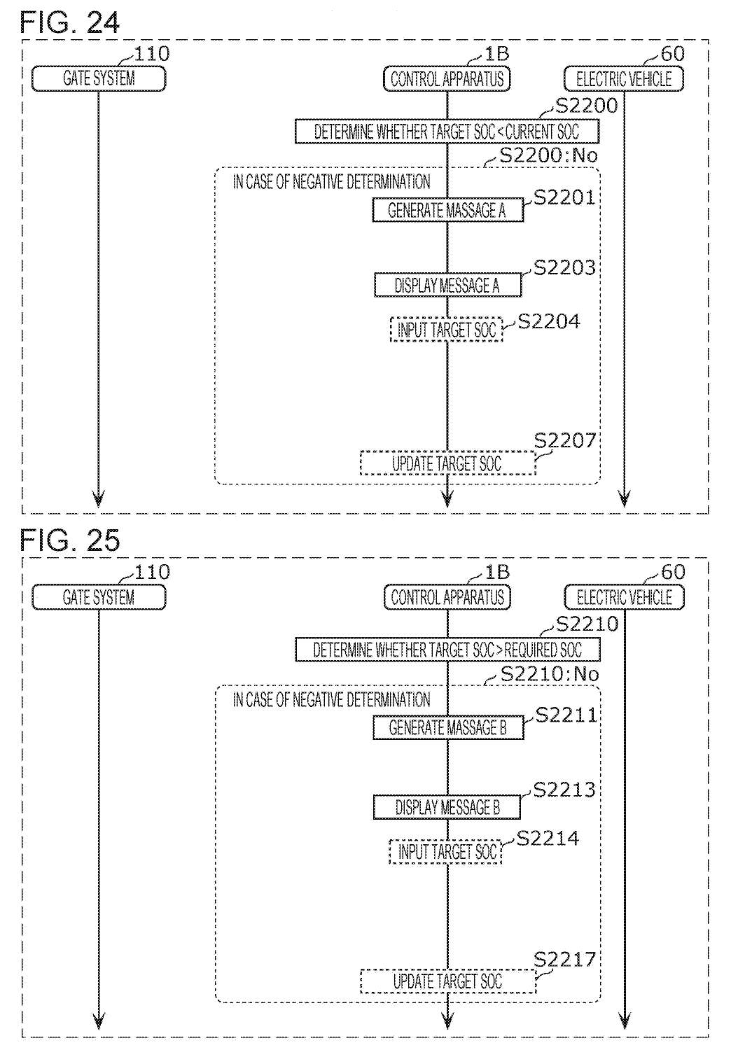

FIG. 25 is a sequence diagram of the third message B display process.

The processes of steps S2210 to S2211 and the process of step S2217 are similar to the processes of steps S1210 to S1211 and the process of step S1217 of the second message B display process in which the control apparatus 1A is read as "control apparatus 1B" and the controllers 10A and 40A are read as "controller 40B", respectively. For this reason, the following description focuses on the processes of steps S2212 to S2216.

Upon completion of the process of step S2211, the controller 40B causes the display of the charge and discharge device 130B to display the message B (step S2213).

When the user who uses the electric vehicle 60 has confirmed the message B displayed on the display of the charge and discharge device 130B and operates the inputter of the charge and discharge device 130B to input a new target SOC (step S2214), the process proceeds to the process of step S2217.

When the determination made in the process of step S2210 is positive or upon completion of the process of step S2217, the third message B display process ends. When the third message B display process is executed after or in place of step S2080, a process that follows the time when the result of the determination made in step S2080 is positive is executed after the time when the determination made in the process of step S2210 is positive or after the process of step S2217.

The electric power charge and discharge system 100B executes a third message C display process that is partly different in process from the second message C display process according to Embodiment 2.

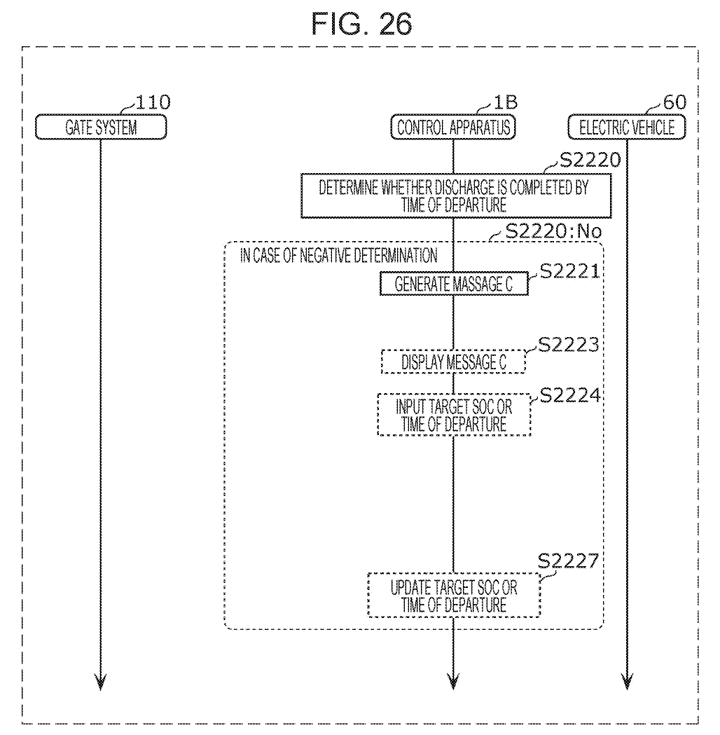

FIG. 26 is a sequence diagram of the third message C display process.

The processes of steps S2220 to S2221 and the process of step S2227 are similar to the processes of steps S1220 to S1221 and the process of step S1227 of the second message C display process in which the control apparatus 1A is read as "control apparatus 1B" and the controllers 10A and 40A are read as "controller 40B", respectively. For this reason, the following description focuses on the processes of steps S2222 to S2226.

Upon completion of the process of step S2221, the controller 40B causes the display of the charge and discharge device 130B to display the message C (step S2223).

When the user who uses the electric vehicle 60 has confirmed the message C displayed on the display of the charge and discharge device 130B and operates the inputter of the charge and discharge device 130B to input a new target SOC or a new time of departure (step S2224), the process proceeds to the process of step S2227.

When the determination made in the process of step S2220 is positive or upon completion of the process of step S2227, the third message C display process ends. When the third message C display process is executed after or in place of step S2080, a process that follows the time when the result of the determination made in step S2080 is positive is executed after the time when the determination made in the process of step S2220 is positive or after the process of step S2227. In the present process, the time of departure may be replaced by the length of time during which the user of the electric vehicle 60 stays in the facility.

The electric power charge and discharge system 100B executes a third message D display process that is partly different in process from the second message D display process according to Embodiment 2.

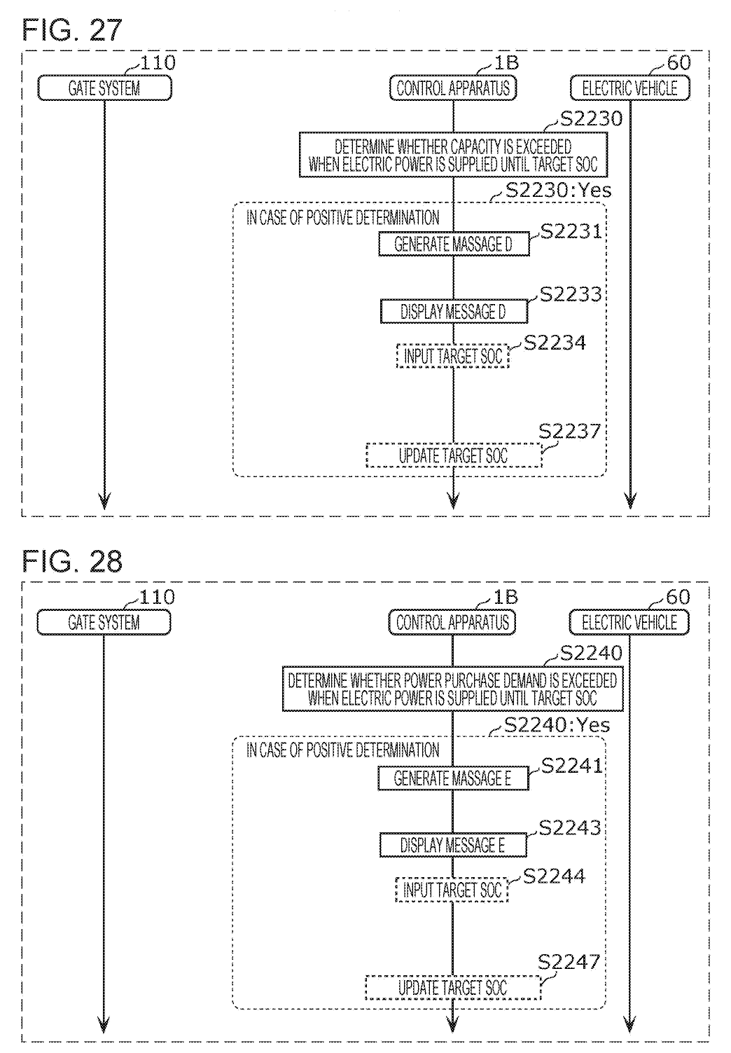

FIG. 27 is a sequence diagram of the third message D display process.

The processes of steps S2230 to S2231 and the process of step S2237 are similar to the processes of steps S1230 to S1231 and the process of step S1237 of the second message D display process in which the control apparatus 1A is read as "control apparatus 1B" and the controllers 10A and 40A are read as "controller 40B", respectively. For this reason, the following description focuses on the processes of steps S2232 to S2236.

Upon completion of the process of step S2231, the controller 40B causes the display of the charge and discharge device 130B to display the message D (step S2233).

When the user who uses the electric vehicle 60 has confirmed the message D displayed on the display of the charge and discharge device 130B and operates the inputter of the charge and discharge device 130B to input a new target SOC (step S2234), the process proceeds to the process of step S2237.

When the determination made in the process of step S2230 is negative or upon completion of the process of step S2237, the third message D display process ends. When the third message D display process is executed after or in place of step S2080, a process that follows the time when the result of the determination made in step S2080 is positive is executed after the time when the determination made in the process of step S2230 is positive or after the process of step S2237.

The electric power charge and discharge system 100B executes a third message E display process that is partly different in process from the second message E display process according to Embodiment 2.

FIG. 28 is a sequence diagram of the third message E display process.

The processes of steps S2240 to S2241 and the process of step S2247 are similar to the processes of steps S1240 to S1241 and the process of step S1247 of the second message E display process in which the control apparatus 1A is read as "control apparatus 1B" and the controllers 10A and 40A are read as "controller 40B", respectively. For this reason, the following description focuses on the processes of steps S2242 to S2246.

Upon completion of the process of step S2241, the controller 40B causes the display of the charge and discharge device 130B to display the message E (step S2243).

When the user who uses the electric vehicle 60 has confirmed the message E displayed on the display of the charge and discharge device 130B and operates the inputter of the charge and discharge device 130B to input a new target SOC (step S2244), the process proceeds to the process of step S2247.

When the determination made in the process of step S2240 is negative or upon completion of the process of step S2247, the third message E display process ends. When the third message E display process is executed after or in place of step S2080, a process that follows the time when the result of the determination made in step S2080 is positive is executed after the time when the determination made in the process of step S2240 is positive or after the process of step S2247.

The electric power charge and discharge system 100B executes a third message FG display process that is partly different in process from the second message FG display process according to Embodiment 2.

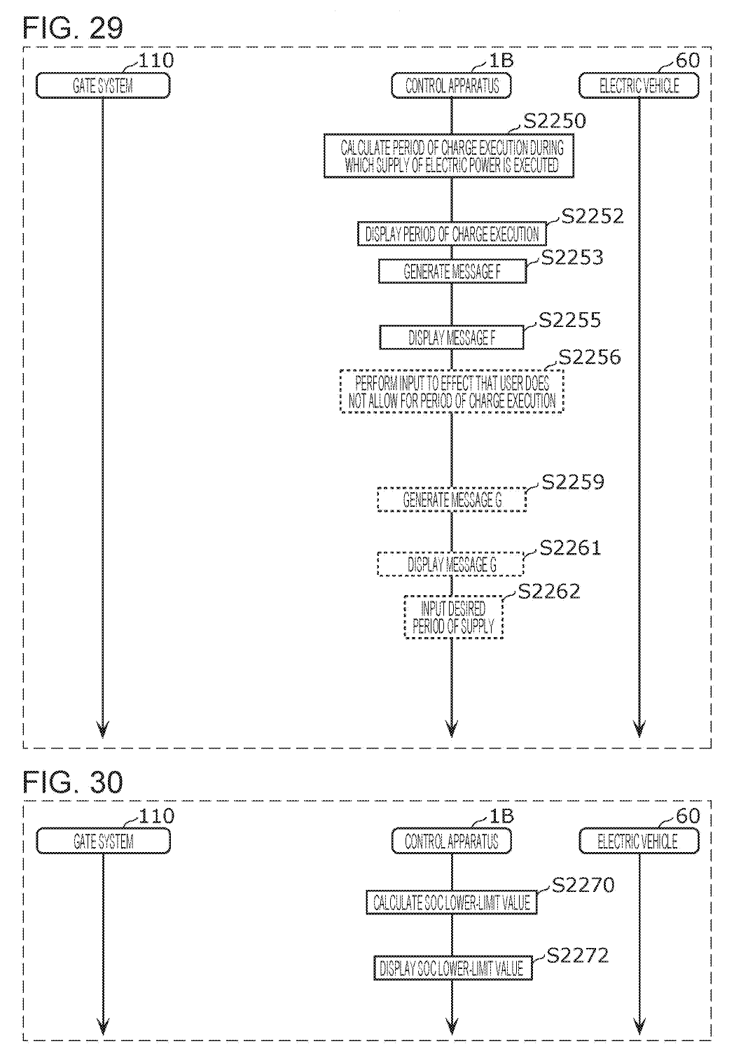

FIG. 29 is a sequence diagram of the third message FG display process.

The process of step S2250, the process of step S2253, and the process of step S2259 are similar to the process of step S1250, the process of step S1253, and the process of step S1259 of the second message FG display process in which the control apparatus 1A is read as "control apparatus 1B" and the controllers 10A and 40A are read as "controller 40B", respectively. For this reason, the following description focuses on the process of step S2252, the processes of steps S2255 to S2256, and the processes of steps S2261 to S2262.

Upon completion of the process of step S2250, the controller 40B causes the display of the charge and discharge device 130B to display the information that indicates the period of charge execution calculated in step S2250 (step S2252), and the process proceeds to the process of step S2253.

The controller 40B causes the display of the charge and discharge device 130B to display the message F generated in the process of step S2253 (step S2255).

When the user who uses the electric vehicle 60 has confirmed the message F displayed on the display of the charge and discharge device 130B and operates the inputter of the charge and discharge device 130B to perform input to the effect that the user who uses the electric vehicle 60 does not allow for the period of charge execution (step S2256), the process proceeds to the process of step S2259.

The controller 40B causes the display of the charge and discharge device 130B to display the message G generated in the process of step S2259 (step S2261).

Having confirmed the message G displayed on the display of the charge and discharge device 130B, the user who uses the electric vehicle 60 operates the inputter of the charge and discharge device 130B to input the desired period of supply (step S2262).

When the user of the electric vehicle 60 has performed input in the process of step S2256 to the effect that the user of the electric vehicle 60 allows for the period of charge execution or upon completion of the process of step S2262, the third message FG display process ends.

When the user of the electric vehicle 60 has performed input in step S2256 to the effect that the user of the electric vehicle 60 allows for the period of charge execution or when the process of step S2085 of the third electric power discharge process is executed when the process of step S2262 has been executed, the controller 40B causes the supply of the electric power of the electric vehicle 60 to be executed over the desired period of supply in the process of step S2085. In other words, the supply of the electric power of the electric vehicle 60 is stopped when the desired period of supply elapses.

Furthermore, prior to the start of the process of step S2065 in the third electric power discharge process, the after-mentioned third message H display process may be performed in addition to or in place of the process of step S2060.

The electric power charge and discharge system 100B executes a third message H display process that is partly different in process from the second message H display process according to Embodiment 2.

FIG. 30 is a sequence diagram of the third message H display process.

The process of step S2270 is similar to the process of step S1270 of the second message H display process in which the control apparatus 1A is read as "control apparatus 1B" and the controllers 10A and 40A are read as "controller 40B", respectively. For this reason, the following description focuses on the process of step S2272.

Upon completion of the process of step S2270, the controller 40B causes the display of the charge and discharge device 130B to display the information that indicates the SOC lower-limit value calculated in step S2270 (step S2272). This allows the user of the electric vehicle 60 to input the target SOC in the process of step S2065 of the third electric power discharge process with reference to the SOC lower-limit value displayed on the display of the charge and discharge device 130B.

Upon completion of the process of step S2272, the third message H display process ends.

### Supplemental Remarks

As noted above, the technology disclosed herein has been described with reference to Embodiments 1 to 3. However, the present disclosure is not limited to these embodiments. Applications to the present embodiments of various modifications conceived of by persons skilled in the art and embodiments constructed by combining constituent elements in different embodiments or modifications are encompassed in the scope of one or more aspects of the present disclosure without departing from the spirit of the present disclosure.

It should be noted that general or specific embodiments may be implemented as a system, an apparatus, a method, an integrated circuit, a program, a computer-readable non-transient storage medium such as a CD-ROM, or any selective combination thereof. For example, the present disclosure may be implemented as a program for causing a computer device to execute a process that is performed by the control apparatus 1.

The present disclosure is widely applicable, for example, to a system that supplies electric power of an electric vehicle to an electric power system or a power receiving apparatus.

What is claimed is:

1. A control method comprising:
in supplying electric power of at least one electric vehicle parked in a facility to an electric power system or at least one power receiving apparatus in the facility, receiving information that a user of the electric vehicle inputted via a terminal and that indicates an SOC (state of charge) at which the user of the electric vehicle wishes for supply of the electric power of the electric vehicle to be stopped; and
stopping the supply of the electric power of the electric vehicle when the SOC at which the user of the electric vehicle wishes for the supply of the electric power of the electric vehicle to be stopped is reached.

2. The control method according to claim 1, further comprising: when the SOC at which the user of the electric vehicle wishes for the supply of the electric power of the electric vehicle to be stopped is less than an SOC needed for the electric vehicle to arrive at a destination from the facility, displaying, on a screen of the terminal, an error message or a message that suggests modifying the SOC at which the user of the electric vehicle wishes for the supply of the electric power of the electric vehicle to be stopped.

3. The control method according to claim 1, further comprising: when a capacity of an electric storage device serving as the power receiving apparatus is exceeded when the electric power of the electric vehicle is supplied to the electric storage device until the SOC at which the user of the electric vehicle wishes for the supply of the electric power of the electric vehicle to be stopped is reached, displaying, on a screen of the terminal, an error message or a message that suggests modifying the SOC at which the user of the electric vehicle wishes for the supply of the electric power of the electric vehicle to be stopped.

4. The control method according to claim 1, further comprising: when a power purchase demand of the electric power system is exceeded when the electric power of the electric vehicle is supplied to the electric power system until the SOC at which the user of the electric vehicle wishes for the supply of the electric power of the electric vehicle to be stopped is reached, displaying, on a screen of the terminal, an error message or a message that suggests modifying the SOC at which the user of the electric vehicle wishes for the supply of the electric power of the electric vehicle to be stopped.

5. The control method according to claim 1, further comprising:
calculating, on the basis of received information that indicates the SOC at which the user of the electric vehicle wishes for the supply of the electric power of the electric vehicle to be stopped, a period of time during which the supply of the electric power of the electric vehicle is executed; and
displaying, on a screen of the terminal, information that indicates the period of time thus calculated.

6. The control method according to claim 5, further comprising causing the terminal to display information that checks with the user of the electric vehicle whether the user of the electric vehicle allows for a period of time during which the supply of the electric power of the electric vehicle is executed.

7. The control method according to claim 6, further comprising:
receiving information that indicates that the user of the electric vehicle does not allow for a period of time during which the supply of the electric power of the electric vehicle is executed; and
upon receiving the information that indicates that the user of the electric vehicle does not allow for a period of time during which the supply of the electric power of the electric vehicle is executed, causing the terminal to display information that prompts inputting of information that indicates a period of time during which the user of the electric vehicle wishes for the supply of the electric power of the electric vehicle to be executed.

8. The control method according to claim 7, further comprising receiving information that the user of the electric vehicle inputted via a screen of the terminal and that indicates a period of time during which the user of the electric vehicle wishes for the supply of the electric power of the electric vehicle to be executed,
executing the supply of the electric power of the electric vehicle over the period of time thus received during which the user of the electric vehicle wishes for the supply of the electric power of the electric vehicle to be executed.

9. The control method according to claim 1, further comprising: adjusting supply power from the electric vehicle so as not to exceed an amount of electricity demanded by a different electric vehicle serving as the power receiving apparatus.

10. The control method according to claim 1, further comprising causing the terminal to display a lower-limit value of an SOC that the user of the electric vehicle inputs via the terminal and at which the user of the electric vehicle wishes for the supply of the electric power of the electric vehicle to be stopped,
wherein the lower-limit value is set to such a value as not to exceed a capacity of power reception of a different electric vehicle serving as the power receiving apparatus.

11. A control apparatus comprising:
a communicator that, in supplying electric power of at least one electric vehicle parked in a facility to an electric power system or at least one power receiving apparatus in the facility, receiving information that a user of the electric vehicle inputted via a terminal and that indicates an SOC at which the user of the electric vehicle wishes for supply of the electric power of the electric vehicle to be stopped; and
a controller that executes the supply of the electric power of the electric vehicle until the SOC at which the user of the electric vehicle wishes for the supply of the electric power of the electric vehicle to be stopped is reached.
